(19) United States
(12) Patent Application Publication
(10) Pub. No.: US 2025/0105993 A1
(43) Pub. Date: Mar. 27, 2025

(54) DOWNLINK (DL) OR UPLINK (UL) TRANSMISSION IN DUPLEX OPERATION

(71) Applicant: Intel Corporation, Santa Clara, CA (US)

(72) Inventors: Yingyang Li, Santa Clara, CA (US); Yi Wang, Santa Clara, CA (US); Gang Xiong, Portland, OR (US); Debdeep Chatterjee, San Jose, CA (US); Sergey Panteleev, Kildare (IE); Salvatore Talarico, Santa Clara, CA (US)

(21) Appl. No.: 18/832,835

(22) PCT Filed: Apr. 4, 2023
(86) PCT No.: PCT/US2023/065322

§ 371 Date: Jul. 24, 2024

Related U.S. Application Data
(60) Provisional application No. 63/333,964, filed on Apr. 22, 2022.

(30) Foreign Application Priority Data
Apr. 5, 2022 (WO) PCT/CN2022/085222

(51) Int. Cl. H04L 5/14; H04W 72/1263

(52) U.S. Cl. CPC H04L 5/14; H04W 72/1263

(57) ABSTRACT

Systems, apparatuses, methods, and computer-readable media are provided for multiple operation modes for downlink (DL) or uplink (UL) transmission in duplex operation, wherein the method comprises: configuring, by a fifth generation (5G) base station (gNB), one or more UL and/or DL resources within a serving cell or bandwidth part (BWP) bandwidth for different symbols; receiving, by a user equipment (UE), an indication of the UL and DL resource configuration; and receiving or transmitting, by a UE, the DL or UL channels/signals, according to the configuration of the DL or UL channels/signals and/or the DCI scheduling the DL or UL channels/signals. Other embodiments may be described and/or claimed.

### CROSS REFERENCE TO RELATED APPLICATION

The present application claims priority to International Patent Application No. PCT/CN2022/085222, which was filed Apr. 5, 2022; and to U.S. Provisional Patent Application No. 63/333,964, which was filed Apr. 22, 2022.

### FIELD

Various embodiments generally may relate to the field of wireless communications. For example, some embodiments may relate to downlink (DL) or uplink (UL) transmission in duplex operation. Specific embodiments may relate to transmission modes or uplink control information (UCI) in duplex operation.

### BACKGROUND

Various embodiments generally may relate to the field of wireless communications.

### BRIEF DESCRIPTION OF THE FIGURES

FIG. 1 depicts an example of non-overlapping sub-band full duplex (NOSB-FD) for new radio (NR), in accordance with various embodiments.

FIG. 2 depicts an example of an operation mode for physical uplink control channel (PUCCH) resources, in accordance with various embodiments.

FIG. 3 depicts an example of physical uplink shared channel (PUSCH) repetition Type A, in accordance with various embodiments.

FIG. 4 depicts an example of configured grant (CG) PUSCH configuration with operation mode A, in accordance with various embodiments.

FIG. 5 depicts an example of separate PUCCH parameters for two operation modes, in accordance with various embodiments.

FIG. 6 schematically depicts an example of PUCCH with operation mode A and PUSCH in regular symbols, in accordance with various embodiments.

FIG. 7 illustrates an example network, in accordance with various embodiments.

FIG. 8 schematically illustrates an example wireless network 800, in accordance with various embodiments.

FIG. 9 is a block diagram illustrating components, according to some example embodiments, able to read instructions from a machine-readable or computer-readable medium (e.g., a non-transitory machine-readable storage medium) and perform any one or more of the methodologies discussed herein.

FIG. 10 illustrates an alternative example network, in accordance with various embodiments.

FIG. 11 depicts an example procedure for practicing the various embodiments discussed herein.

FIG. 12 depicts another example procedure for practicing the various embodiments discussed herein.

FIG. 13 depicts another example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

### Multiple Operation Modes for DL or UL Transmission in Duplex Operation

Time Division Duplex (TDD) may be used in commercial new radio (NR) deployments, where the time domain resource is split between downlink (which may also be referred to as “DL”) and uplink (which may also be referred to as “UL”) symbols. Allocation of a limited time duration for the uplink in TDD may result in reduced coverage and increased latency for a given target data rate. To improve the performance for uplink transmission in TDD system, simultaneous transmission and reception of downlink and uplink respectively, also referred to as “full duplex communication” may be used. One such technique for full duplex communication may be Non-Overlapping Sub-Band Full Duplex (NOSB-FD).

For NOSB-FD, within a carrier bandwidth, some bandwidth may be allocated as UL (referred to herein as UL SB”), while some bandwidth can be allocated as DL (referred to herein as “DL SB”) within the same symbol. However, the UL SB and DL SB may be non-overlapping in frequency domain. Under this operational mode, at a given symbol, a base station such as a gNB may simultaneously transmit DL signals and receive UL signals, while a mobile device such as a UE may only transmit or receive during that symbol.

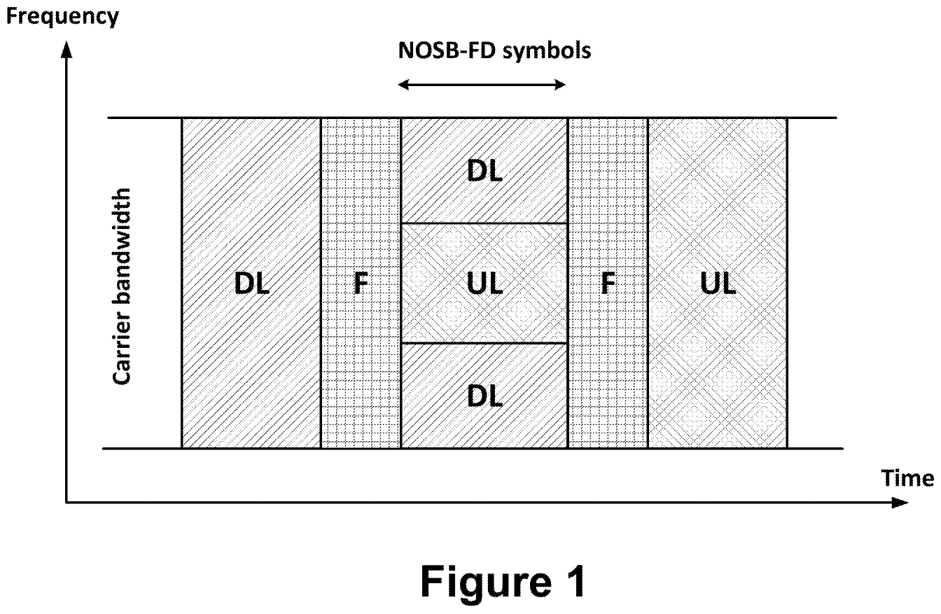

FIG. 1 illustrates one example of Non-Overlapping Sub-Band Full Duplex (NOSB-FD) for a NR system. In the figure, in the NOSB-FD symbols (which may be referred to as “Full Duplex (FD) symbols” for brevity), part of carrier bandwidth is allocated for DL while remaining part of carrier bandwidth is allocated for UL. Other symbols may be referred to as “regular symbols” in this disclosure. A regular symbol may be used for DL transmission only or for UL transmission only. A regular symbol may be a DL or UL symbol that is semi-statically configured by higher layer signaling, e.g., by tdd-UL-DL-ConfigurationCommon or tdd-UL-DL-ConfigurationDedicated. A regular symbol may be a DL or UL symbol that is dynamically indicated by DCI format 2_0 (slot format indication). Further, a regular symbol may be a flexible symbol (which may be referred to as a “F” symbol) configured by the high layer signaling or indicated by DCI format 2_0 if it is not configured or indicated as a NOSB-FD symbol.

Embodiments herein relate to system and/or methods of multiple operation modes for DL or UL transmission in duplex operation. In particular, embodiments may include or relate to one or more of the following:
Operation mode determination for a DL or UL transmission
Flexible operation mode for a DL or UL transmission
Explicitly configured/indicated operation mode for a DL or UL transmission

The available DL or UL frequency resource and the corresponding interference level in a NOSB-FD symbol may be different from a regular symbol. Correspondingly, the suitable DL and/or UL transmission parameters can be different in a NOSB-FD symbol or a regular symbol.

In one embodiment, the transmission parameters in the configuration of the DL or UL transmission may be or include one or more of:
DL or UL bandwidth part (BWP)
Frequency domain resource information
Modulation and coding scheme (MCS) table
Transform precoding (i.e., information related to a discrete fourier transform-spread-orthogonal frequency division multiplex (DFT-s-OFDM) or other orthogonal frequency division multiplex (OFDM) waveform)
Power control parameters
Rate matching pattern for physical downlink shared channel (PDSCH)
Invalid symbol pattern for physical uplink shared channel (PUSCH)
Spatial Information
Transmit power scaling for DL signals and channels relative to a reference; this could also be represented as relative differences in DL transmit power spectral density (PSD) in regular (DL or F) symbols and NOSB-FD symbols. In one example, different values of powerControlOffset and powerControlOffsetSS may be provided for a Non-Zero-Power channel state information-reference signal (NZP CSI-RS) resource configuration for regular and NOSB-FD symbols.

Throughout this disclosure, different operation modes for a DL or UL transmission are introduced to identify the operations in a NOSB-FD symbol and/or a regular symbol. In some embodiments, such behavior based on different operation modes may be applied whenever the NOSB-FD symbols are configured. In other embodiments, the behavior may be only applied when the configured UL PRBs in the NOSB-FD symbols are different from the UL BWP. Further, the applicability of the behavior may vary per slot or per group of slots, if the configuration of NOSB-FD symbols can be different in different slots or different groups of slots.

In an embodiment, a UE may be configured to expect that any UL transmission that is contained within the intersection of the PRBs of active UL BWP in an UL symbol and the PRBs within the UL subband (or UL PRBs) in a NOSB-FD symbol may be transmitted spanning one or more of regular (UL or F symbols) and NOSB-FD symbols, while for any other UL transmission that may be contained only within the active UL BWP or only within UL PRBs in NOSB-FD symbol, the transmission may not span a mix of regular and NOSB-FD symbols. As used herein, a “transmission” may include repetitions of a single channel or signal. Alternatively, a “transmission” may be just one repetition of a single channel or signal.

In an embodiment, an operation mode A is for the transmission in NOSB-FD symbols while an operation mode B is for the transmission in regular symbols. Equivalently, without explicitly introducing concept of ‘operation mode’, the above operations can be directly determined by the occupied NOSB-FD symbol and/or regular symbol, or the above operations can refer to the different set of transmission parameters. In the rest of the disclosure, references to “operation modes A/B/C” are made for brevity, but are intended to include examples when the definition of duplex “operation modes” may be implicit.

In an embodiment, different operation modes are defined explicitly or determined implicitly for UL transmissions only while reception of a DL transmissions is transparent to whether the DL channel/signal is received in regular (DL or F) symbols or NOSB-FD symbols.

### Mechanisms to Determine Operation Mode for a DL or UL Transmission

An operation mode for the DL or UL transmission may be determined based on a time unit that includes the allocated symbols of the DL or UL transmission. In other words, the same operation mode applies to the DL or UL transmission in the time unit. The time unit can include all symbols in a slot, a PUCCH slot, or multiple slots used by the DL or UL transmission. Alternatively, the time unit can include exactly the allocated symbols of the DL or UL transmission in a slot, a PUCCH slot, or multiple slots used by the DL or UL transmission. That is, an operation mode for the DL or UL transmission can be determined based on the allocated symbols of the DL or UL transmission.

For example, for PDSCH or PUSCH, a time unit may just include the allocated symbols indicated by the time domain resource allocation (TDRA) information field in the downlink control information (DCI) or configured by high layer signaling.

For example, for CSI-RS transmission, a time unit may include the multiple consecutive or non-consecutive symbols configured with CSI-RS in the CSI-RS resource set.

For example, for DMRS bundling for multi-slot PUSCH including PUSCH repetition type A/B and transport block (TB) processing over multiple slots (TBoMS) and PUCCH repetitions, a time unit may include the allocated symbols in a nominal or actual time domain window, where UE is required to maintain phase continuity and power consistency in the nominal or actual time domain window.

For example, for PDSCH, PUSCH, PUCCH, if configured or indicated with repetitions, a time unit may include the allocated symbols or transmission occasions of the multiple repetitions. Alternatively, a time unit may include a single or a number of the multiple repetitions of the DL or UL transmission. The above multiple repetitions may carry the same TB or UCI.

For example, for CSI-RS or SRS, if configured or indicated with repetitions, a time unit may include the allocated symbols or transmission occasions of the multiple repetitions. Alternatively, a time unit may include a single or a number of the multiple repetitions.

For example, for TBoMS, a time unit may include the allocated symbols of the allocated slots for TBoMS transmission with or without repetitions. Alternatively, for TBoMS, a time unit may include a single repetition of a TB that spans multiple slots or a number of repetitions of a TB spanning multiple slots.

In an embodiment, if at least one symbol of a time unit is a NOSB-FD symbol, a UE uses operation mode A in the time unit. Otherwise, the UE uses operation mode B in the time unit.

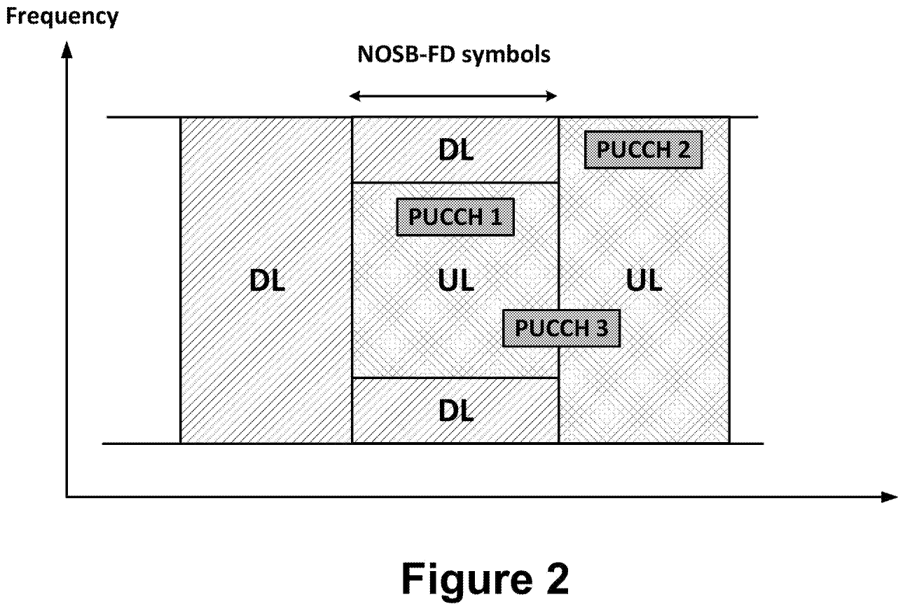

FIG. 2 illustrates one example on the operation mode for the PUCCH resources. PUCCH resource 1 occupies only NOSB-FD symbols, so PUCCH resource 1 is associated with operation mode A. PUCCH resource 2 occupies only regular symbols, so PUCCH resource 2 is associated with operation mode B. Further, since PUCCH resource 3 contains both NOSB-FD symbols and non-NOSB symbols, PUCCH resource 3 is associated with operation mode A.

In another embodiment, for a given time unit, the operation mode for the time unit may be determined based on the first symbol of the time unit being a NOSB-FD symbol or a regular (DL/UL/FL) symbol. Similarly, for a DL/UL transmission involving repetitions, the operation mode for a time unit spanning multiple repetitions may be determined based on the first symbol of the first repetition within the time unit being a NOSB-FD symbol or a regular (DL/UL/FL) symbol.

In another embodiment, if all symbols of a time unit are NOSB-FD symbols, a UE may use operation mode A in the time unit. On the other hand, if all symbols of a time unit are regular symbols, a UE may use operation mode B in the time unit. The UE may not be configured expect that a time unit include both NOSB-FD symbols and regular symbols. With this option, in FIG. 2, PUCCH resource 1 is valid and is associated with operation mode A. PUCCH resource 2 is valid and is associated with operation mode B. However, since PUCCH resource 3 contains both NOSB-FD symbols and non-NOSB symbols, PUCCH resource 3 is invalid.

In another embodiment, if all symbols of a time unit are NOSB-FD symbols, a UE uses operation mode A in the time unit; if all symbols of a time unit are regular symbols, a UE uses operation mode B in the time unit. Further, if some symbols of a time unit are NOSB-FD symbols while remaining symbols of a time unit are regular symbols, a UE uses operation mode C in the time unit. For a transmission parameter of operation mode C, gNB may configure a different value from operation mode A and/or operation mode B for a DL or UL transmission mapped to a time unit involving both NOSB-FD and regular symbols.

In another embodiment, if any symbol of a time unit is a regular symbol, a UE may use operation mode B in the time unit. Otherwise, the UE uses operation mode A in the time unit.

### Implicit Operation Mode in the Configuration of a DL or UL Transmission

In the configuration of a DL or UL transmission, a UE may be configured with the transmission parameters that are associated with one or multiple operation modes (e.g., Operation Modes A, B, C, etc.). An operation mode for the DL or UL transmission may be determined based on a time unit that includes the allocated symbols of the DL or UL transmission. Then, the UE may use the transmission parameters of the determined operation mode to perform the DL or UL transmission.

In one example, for dynamic PDSCH/PUSCH scheduling, the related configuration of the transmission parameters of one or multiple operation modes can be provided by high layer, e.g., in PDSCH-Config or PUSCH-Config. In another example, for a SPS or CG PUSCH configuration, the related configuration of the transmission parameters of one or multiple operation modes can be provided by high layer, e.g., in SPS-Config or ConfiguredGrantConfig. In another example, for PUCCH configuration, the related configuration of the transmission parameters of one or multiple operation modes can be provided by high layer, e.g., in PUCCH-Config.

In one embodiment, the DL or UL transmission in different time units may be associated with same or different operation modes. UE can perform the DL or UL transmission in a time unit according to the corresponding parameters of the operation mode.

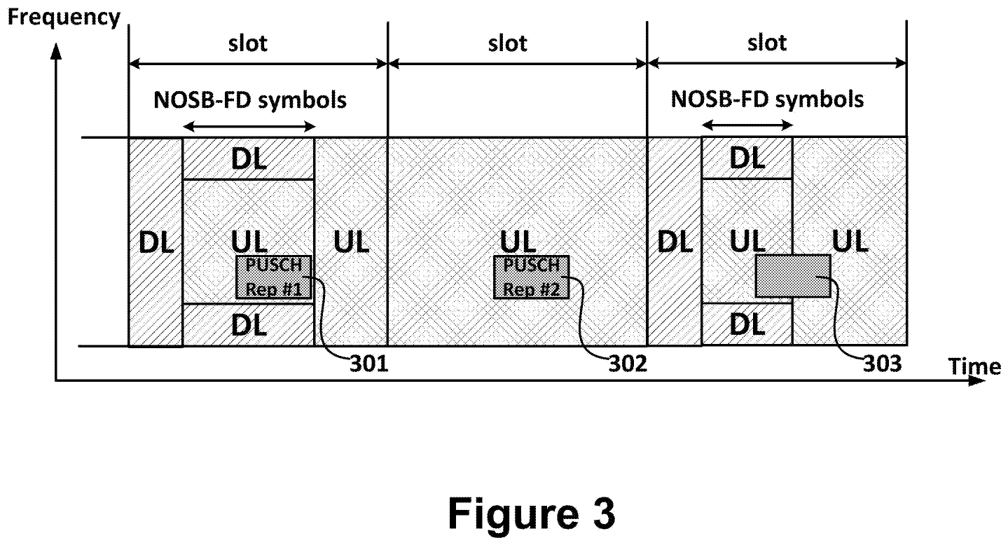

FIG. 3 illustrates one example on the resource allocation for PUSCH repetition Type A. For the sake of discussion herein, it is assumed that two repetitions are configured or indicated for the PUSCH. The first PUSCH repetition 301 is in NOSB-FD symbols, so it is associated with operation mode A. The second PUSCH repetition 302 is in non NOSB-FD symbols, so it is associated with operation mode B. Both repetitions are valid for transmission. These two repetitions may use different parameters, e.g., different UL power control for PUSCH Rep #1 and Rep #2.

In another embodiment, for a DL or UL transmission, an operation mode is determined across multiple time units of the DL or UL transmission. For example, for CSI-RS transmission, a time unit may only include symbols of a CSI-RS resource, then the multiple time units are associated with the CSI-RS resources in a CSI-RS resource set. For DMRS bundling, a time unit may only include symbols of PUSCH in a slot or a repetition, then the multiple time units are associated with the PUSCHs for DMRS bundling in a nominal or actual time domain window where UE is required to maintain phase continuity and power consistency. For PDSCH, PUSCH, CSI-RS or SRS, including TBoMS, if configured or indicated with repetitions, if a time unit only includes the allocated symbols of a repetition, then the multiple time units include all the repetitions. The multiple time units may carry the same TB or UCI. In this embodiment, the transmit power control (TPC) command in the DCI applies to the power control across the multiple time units with the determined operation mode.

In one option, for a DL or UL transmission, UE may expect that the DL or UL transmission in the multiple time units must use the same operation mode. Consequently, UE performs the DL or UL transmission in the multiple time units according to the corresponding set of parameters of the operation mode. With this embodiment, in FIG. 3, PUSCH repetition #1 301 and #2 302 are not valid resources for PUSCH repetition Type A.

In another option, for a DL or UL transmission, an operation mode can be determined based on the first of the multiple time units. Then, UE can preform the DL or UL transmission in any of the multiple time units with the same operation mode. The UE may drop the DL or UL transmission in a time unit if it is not associated with same operation mode. Specifically, for PUCCH with repetitions, the time resources of the other PUCCH repetitions are determined by the first PUCCH repetition. With this embodiment, in FIG. 3, PUSCH repetition #2 302 is not valid for PUSCH transmission since it is associated with a different operation mode. PUSCH repetition #2 302 may be dropped.

In another option, for a DL or UL transmission, an operation mode can be determined based on the first of the multiple time units. Then, UE can perform the DL or UL transmission following the same operation mode in all the multiple time units, regardless of the operation mode determined in a time unit. With this embodiment, in FIG. 3, PUSCH repetition #2 302 is not valid for PUSCH transmission since it is associated with a different operation mode. However, PUSCH repetition #2 302 is transmitted with the operation mode of PUSCH repetition #1 301.

In another option, for a DL or UL transmission with repetitions, e.g., PUSCH repetition Type A with counting based on available slot or TBoMS or PUCCH repetitions, an operation mode can be determined based on the first of the multiple time units. Then, a slot is not considered as an available slot if the allocated symbols in the slot is associated with a different operation mode. The DL or UL transmission can be delayed to the next available slot. With this embodiment, in FIG. 3, PUSCH repetition #2 302 is not valid for PUSCH transmission since it is associated with a different operation mode. The slot of PUSCH repetition #2 302 is not considered as available slot, therefore, PUSCH repetition #2 can be delayed to the next available slot 3 03.

In an embodiment, for a DL or UL transmission, UE may expect that every time unit of the DL or UL transmission must use the same operation mode. Consequently, UE can perform the DL or UL transmission with the corresponding set of parameters of the operation mode.

In an embodiment, for UL/DL channels/signals with repetitions, a UE may follow a single operation mode for all repetitions irrespective of the actual mapping to symbols involving regular or NOSB-FD symbols, wherein the operation mode to be used is determined based on one or more of: (1) the applicable operation mode for the first symbol or first time unit; (2) as configured via higher layers or dynamically indicated by the gNB; (3) as determined based on specified rules to determine a single operation mode.

As an example of the last determination method, a UE may be configured to use operation mode A if any NOSB-FD symbol is included within the set of repetitions, etc.

### Explicitly Configured or Indicated Operation Mode for a DL or UL Transmission

For a DL or UL transmission, a first operation mode may be configured by higher layers or dynamically indicated by a DCI. On the other hand, based on a time unit with the allocated symbols of the DL or UL transmission, a second operation mode may be determined. Certain limitations may be applied based on the first and second operation mode for the DL or UL transmission.

In an embodiment, in a configuration of a DL or UL transmission, a UE may be configured with corresponding parameters that are associated with an operation mode. The operation modes for the different configurations of the DL or UL transmission may be same or different. For a semi-statically configured DL or UL transmission, UE can receive or transmit in the configured time resource according to the operation mode configured in the configuration of the DL or UL transmission.

In one example, in the configuration of a configured grant (CG) PUSCH configuration, PUCCH configuration, sounding reference signal (SRS) resource configuration, PDCCH configuration, semi-persistent scheduling (SPS) PDSCH configuration, CSI-RS resource configuration or CSI report configuration, the associated operation mode can be configured together. gNB may configure two separate PUCCH-Config, and each PUCCH-Config may be associated with one operation mode. gNB may configure multiple ConfiguredGrantConfig, and each ConfiguredGrantConfig is associated with one operation mode. gNB may configure multiple Search Space (SS) sets and/or CORESETs, and each SS set and/or CORESET may be associated with one operation mode.

The operation modes for the different DL or UL transmission may be separately configured.

For different UL/DL transmission, different mechanism to determine the operation mode can be applied. For example, gNB may configure separate PUCCH resources or CG PUSCH resources for two operation modes, while gNB only configures single SRS resource for both NOSB-FD and regular operation. For another example, for PUCCH resource determination, the operation mode for a UL/DL transmission in a slot can be determined by the symbol type in the slot/sub-slot, while for PUSCH resource determination, the operation mode for a UL/DL transmission from symbol l₁˜lₙ is determined by the symbol type in symbol l₁˜lₙ.

A set of transmission parameters can be configured and commonly applied to multiple configurations of the DL or UL transmissions with different operation modes. If a transmission parameter is not configured in a configuration of the DL or UL transmission, the parameter may apply for a configuration of the DL or UL transmission with default operation mode. For example, the default operation mode can be the operation mode B. Alternatively, the parameter can be applicable for all the configurations of the DL or UL transmission with any operation mode, e.g., applicable to both operation mode A and mode B. Alternatively, the parameter will apply to a configuration of the DL or UL transmission if the same parameter is not configured. Alternatively, if a parameter is commonly configured, and if the same parameter is also configured in a configuration of the DL or UL transmission, the UE can follow the dedicated configured value of the parameter for the configuration of the DL or UL transmission.

In an embodiment, gNB may explicitly indicate an operation mode in a DCI that schedules the DL or UL transmission.

In one option, when multiple configurations of a DL or UL transmission are configured with different operation modes, UE can receive or transmit in the scheduled time resource according to the configuration with the indicated operation mode by the DCI. For example, gNB can configure two frequency regions for FDRA for dynamically scheduled PUSCH or PDSCH, e.g., one frequency region is the active BWP and the other is within the configured PRBs, and each FDRA is associated with one operation mode. gNB indicates the operation mode in the scheduling DCI, and UE interprets FDRA for the scheduled PDSCH/PUSCH within the corresponding frequency region.

In another option, when a configuration of a DL or UL transmission can be configured with the transmission parameters with one or multiple operation modes, UE can perform the DL or UL transmission according to the parameters of the indicated operation mode by the DCI.

In the above options, the DCI format for DL assignment or uplink grant may include one bit to indicate the operation mode. Note that the DCI format may include DCI format 0_1, 0_2 or 1_0, 1_2. For fallback DCI format, i.e., DCI format 0_0 or 1_0, explicit indication of the operation mode is not included. Alternatively, the indicated operation mode can be determined by the existing fields in the DCI. For example, based on the value of PDSCH-to-HARQ_feedback timing indicator field, i.e., K1, UE know determine the UL slot or PUCCH slot for the HARQ-ACK transmission. The operation mode for the HARQ-ACK transmission can be determined by the UL slot or PUCCH slot. Accordingly, the TPC command in the DCI applies to the power control for the HARQ-ACK transmission with the indicated operation mode.

In an embodiment, for a DL or UL transmission with a configured or indicated operation mode, UE may expect that the configured or indicated operation mode is aligned with the operation mode determined in any time unit that includes the allocated symbols of the DL or UL transmission.

In an embodiment, for a DL or UL transmission with a configured or indicated operation mode, if a different operation mode is determined in a time unit of the DL or UL transmission, the UE may drop the DL or UL transmission in the time unit, or drop the DL or UL transmission entirety.

For example, if a gNB configures two CG PUSCH configurations for a UE, CG PUSCH configuration 1 is associated with operation mode A, and CG PUSCH configuration 2 is associated with operation mode B. If CG PUSCH configuration 2 is configured on a set of symbols belonging to operation mode A, the UE can drop the CG PUSCH configuration 2 on the set of symbols. Alternatively, the UE can drop any transmission of the CG PUSCH configuration 2.

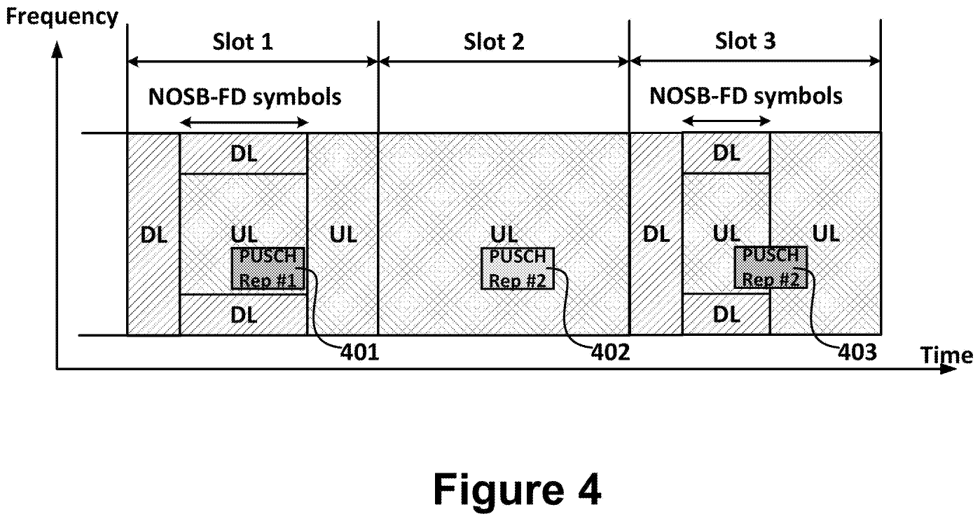

FIG. 4 illustrates one example on CG PUSCH configuration with operation mode A. For the sake of discussion herein, it may be assumed that the number of repetitions is two. The first CG PUSCH resource 401 is in NOSB-FD symbols, so it is associated with operation mode A. The second CG PUSCH resource 402 is in regular symbols, so it is not associated with operation mode A. The second CG PUSCH resource 402 is not valid and can be dropped.

In an embodiment, for a DL or UL transmission with a configured or indicated operation mode, if the DL or UL transmission is configured with repetitions, e.g., PUSCH repetition Type A with counting based on available slots or TBoMS or PUCCH repetitions, a slot is not considered as available slot if a different operation mode is determined in the slot of the DL or UL transmission. The DL or UL transmission can be delayed to the next available slot. With this option, in FIG. 4, since the second CG PUSCH resource 402 in slot 2 is not associated with operation mode A, the slot 2 is not considered as available slot, therefore, the second CG PUSCH resource can be delayed to the next available slot 403 or dropped.

In an embodiment, for a DL or UL transmission with a configured or indicated operation mode, if a different operation mode is determined in a slot of the DL or UL transmission, different solutions can be applied depending on the configured or indicated operation mode. For one configured or indicated operation mode, e.g., operation mode A, UE may still receive or transmit the DL or UL transmission. That is, UE can neglect the difference of operation modes. On the other hand, for the other configured or indicated operation mode, e.g., operation mode B, the UE may drop the DL or UL transmission in the slot or drop the DL or UL transmission in any slot. Alternatively, the slot is not considered as available slot.

In an embodiment, for a DL or UL transmission with a configured or indicated operation mode, UE may receive or transmit the DL or UL transmission based on the configured or indicated operation mode, regardless of the operation mode determined in a time unit of the DL or UL transmission.

### UCI Transmission and Reception in Duplex Operation

In addition to the above, embodiments herein relate to apparatuses, systems, and methods for UCI transmission and reception in duplex operation. For example, aspects of various embodiments may include or relate to one or more of the following:
UCI multiplexing/prioritization for PUCCHs with consideration of operation mode
UCI multiplexing/prioritization for PUCCH and PUSCH with consideration of operation mode
PUCCH repetition with consideration of operation mode
SPS hybrid automatic repeat request-acknowledgement (HARQ-ACK) Deferral

The available DL or UL frequency resource and the corresponding interference level in a NOSB-FD symbol may be different from a regular symbol. Correspondingly, the suitable UCI transmission parameters may be different in a NOSB-FD symbol or a regular symbol.

UCI transmission parameters may include one or more of the following:
PUCCH parameters, including one or more of the following:
   Frequency domain resource information, e.g., starting physical resource block (PRB) and number of PRBs.
   Frequency hopping
   Time domain resource information, e.g., starting symbol and duration, slot or sub-slot based PUCCH resource.
   PUCCH format
   π/2-binary phase shift keying (BPSK)
   Power control parameters
   Spatial Information
   maxCodeRate
   Repetition number
   maxPayloadSize for each PUCCH resource set
   Orthogonal cover code (OCC) parameters
UCI on PUSCH parameters
   betaOffsets
   scaling factor

Similarly to the previous section, different operation modes for UCI transmission may be used herein to differentiate UCI transmission behavior for a NOSB-FD symbol and/or a regular symbol. An operation mode A may be used herein to refer to the transmission in NOSB-FD symbols, while an operation mode B may be used herein to refer to transmission in regular symbols. Equivalently, without explicitly introducing concept of ‘operation mode’, the above operations may be determined by the occupied NOSB-FD symbol and/or regular symbol, or the above operations may refer to the different set of transmission parameters. In the rest of the disclosure, references to “operation modes A/B/C” are made for brevity, but are intended to include examples when the definition of duplex “operation modes” may be implicit.

Moreover, in some examples, a single operation mode may be applicable to both a NOSB-FD symbol and a regular symbol.

### Separate UCI Transmission Parameters Associated With Different Operation Modes

In one embodiment, separated configurations of PUCCH resources or PUCCH resource sets may be configured with different operation modes. In one option, gNB may configure separate PUCCH resources and each PUCCH resource is associated with one operation, e.g., gNB configures separate PUCCH-Config, and each PUCCH-Config is associated with one operation mode. In one example, for PUCCH resource for CSI report PUCCH-CSI-Resource, gNB can configure two PUCCH-CSI-Resource and each PUCCH-CSI-Resource is associated with one operation mode. Alternatively, for PUCCH resource for CSI report PUCCH-CSI-Resource, gNB can configure two pucch-Resource and each pucch-Resource is associated with one operation mode. In one example, for PUCCH resource for SR in SchedulingRequestResourceConfig, gNB can configure two Resource and each Resource is associated with one operation mode. In another option, gNB configures multiple sets of parameters for one PUCCH resource, e.g., in one PUCCH-Config. The set of parameters includes at least one of PUCCH parameters listed above.

If a UE is configured with multiple priorities, in one example, a PUCCH-Config for a priority is associated with one operation mode. In another example, multiple PUCCH-Config can be configured for a priority, and each PUCCH-Config is associated with an operation mode. Alternatively, a PUCCH-Config is configured for a priority, and the PUCCH-Config for a priority can be associated with multiple operation modes.

For both options, in one example, for a PUCCH resource with an index, same time domain resource information may apply to all PUCCH resources with same index of all operation modes, or UE does not expect different time domain resource information for different operation mode. In another example, time domain resource information can be separately configured for different option mode.

As an extension of the above options, some parameters in the PUCCH-Config may be commonly applied for the configurations for different operation modes. The remaining parameters may be separately configured for different operation modes

In one embodiment, separate configuration of UCI on PUSCH can be configured with different operation modes. In one option, gNB configures separate UCI-on-PUSCH, and each UCI-on-PUSCH is associated with one operation mode. In another option, gNB configures two sets of parameters in one UCI-on-PUSCH. The set of parameters includes at least one of PUSCH parameters provided above.

### UCI Transmission Parameter Determination According to Operation Mode

In one embodiment, for PUCCH, in one option, the operation mode for UCI transmission by PUCCH is indicated by gNB, e.g., by DL assignment scheduling the PDSCH with HARQ-ACK PUCCH, or configured by gNB as part of semi-static PUCCH configuration, e.g., for P/SP-CSI/SR/SPS HARQ-ACK PUCCH.

In another option, the operation mode for UCI transmission by PUCCH is determined by the operation mode associated with the time unit in which PUCCH resource locates.

The time unit can include all symbols in a slot, all symbols in a PUCCH slot (slot or sub-slot), or multiple slots/PUCCH slots used PUCCH transmission. Alternatively, the time unit can include exactly the allocated symbols of the PUCCH transmission in a slot or multiple slots.

To determine operation mode associated with the time unit, in one option, if at least one symbol of a time unit is a NOSB-FD symbol, operation mode A is associated with the time unit. Otherwise, operation mode B is associated with the time unit. In another option, for a given time unit, the operation mode associated with the time unit may be determined based on the first symbol of the time unit being a NOSB-FD symbol or a regular (DL/UL/FL) symbol. Similarly, for a UL transmission involving repetitions, the operation mode associated with a time unit spanning multiple repetitions may be determined based on the first symbol of the first repetition within the time unit being a NOSB-FD symbol or a regular (DL/UL/FL) symbol. In another option, if all symbols of a time unit are NOSB-FD symbols, operation mode A is associated with the time unit. On the other hand, if all symbols of a time unit are regular symbols, operation mode B is associated with the time unit. The UE doesn't expect that a time unit include both NOSB-FD symbols and regular symbols. In another option, if all symbols of a time unit are NOSB-FD symbols, operation mode A is associated with the time unit; if all symbols of a time unit are regular symbols, operation mode B is associated with the time unit. Further, if some symbols of a time unit are NOSB-FD symbols while remaining symbols of a time unit are regular symbols, a third mode, e.g., operation mode C may be associated with the time unit. In another option, if any symbol of a time unit is a regular symbol, operation mode B is associated with the time unit. Otherwise, operation mode A is associated with the time unit.

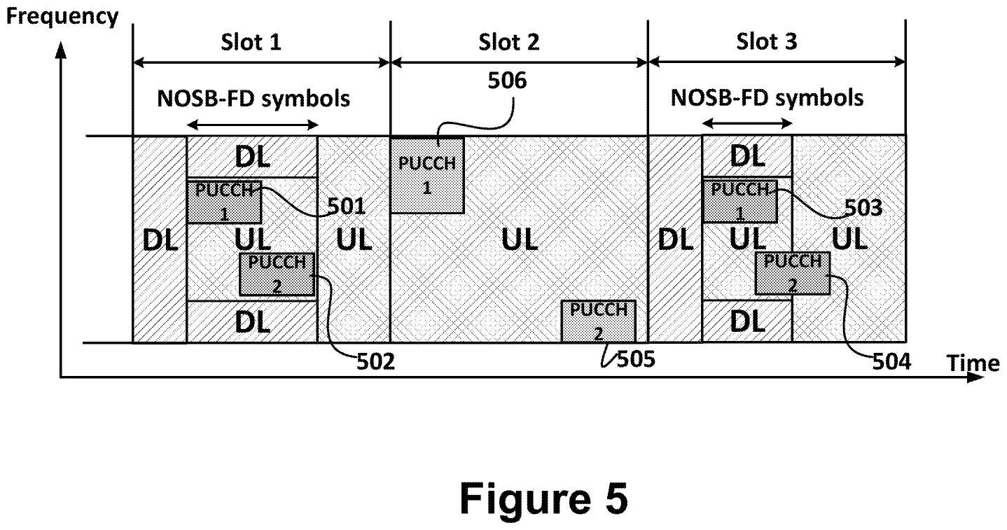

FIG. 5 illustrates one example on separate UCI transmission parameters for PUCCH that are associated with the two operation modes. For the HARQ-ACK feedback in slot 1 or 3, the PUCCH parameters associated with operation mode A will apply since NOSB-FD symbols exist there (e.g., for PUCCH 1 501, PUCCH 2 502, PUCCH 1 503, and PUCCH 2 504). On the other hand, for the HARQ-ACK feedback in slot 2, the PUCCH parameters associated with operation mode B will apply (e.g., for PUCCH 1 506 and PUCCH 2 505).

In one embodiment, for UCI on PUSCH, in one option, the operation mode for UCI transmission on the PUSCH may be indicated by gNB, e.g., by UL grant scheduling the PUSCH and/or DL assignment scheduling the PDSCH with HARQ-ACK PUCCH, or configured by gNB as part of CG PUSCH configuration and/or part of PUCCH configuration. In one example, UE may not be configured to expect that the operation mode indicated for PUSCH and PUCCH is different. In another example, UE uses the operation mode indicated for PUSCH. In another option, the operation mode for UCI transmission on the PUSCH is determined by the operation mode associated with the time unit in which PUSCH resource locates.

The time unit can include all symbols in a slot, or multiple slots used PUSCH transmission. Alternatively, the time unit can include exactly the allocated symbols of the PUSCH transmission in a slot or multiple slots. The mechanism to determine the operation mode associated with the time unit for PUSCH is similar to the case of PUCCH as provided above.

For both embodiments above, in one option, for a UCI transmission parameter associated with an operation mode, UE does not expect PUCCH/PUSCH carrying the UCI is not confined within the symbols (NOSB-FD or regular symbol) for the corresponding operation mode. For example, if an indicated PUCCH resource for regular operation is chosen, UE does not expect any symbol the PUCCH resource is in a NOSB-FD symbol. Typically, at least PUCCH/PUSCH dynamically scheduled by gNB can ensure the indicated PUCCH/PUSCH resource confined within the symbols for the corresponding operation mode. For configured PUCCH/PUSCH resource, e.g., for SR/P/SP-CSI/SPS HARQ-ACK or CG PUSCH, gNB may also ensure the PUCCH/PUSCH resource confined within the symbols for the corresponding operation mode. Alternatively, a PUCCH/PUSCH resource may be not confined within the symbols for the corresponding operation mode. UE considers such PUCCH/PUSCH resource as invalid PUCCH/PUSCH resource. In FIG. 5, because a PUCCH resource 2 504 in slot 3 overlaps with a regular symbol and NOSB-FD symbol, therefore, the PUCCH resource 2 504 in slot 3 is invalid.

In another option, for a UCI transmission parameter associated with an operation mode, PUCCH/PUSCH carrying the UCI can overlap with both NOSB-FD and regular symbols. With this option, in FIG. 5, it is not limited that a PUCCH resource associated with operation mode A can only use NOSB-FD symbols. Therefore, all PUCCH resources, including PUCCH resource 2 504, shown in FIG. 5 are valid configuration.

In another option, for a UCI transmission parameter associated with operation mode A, UE does not expect PUCCH/PUSCH carrying the UCI is not confined within the UL SB or overlaps with DL SB in a NOSB-FD symbol. With this option, in FIG. 5, any of PUCCH resources 501-504 may be considered to be a valid PUCCH resource.

In another option, for a UCI transmission parameter associated with an operation mode, if the PUCCH/PUSCH carrying the UCI is not aligned with the operation mode determined by the symbols of the PUCCH/PUSCH resource, UE may cancel or delay a PUCCH/PUSCH repetition, or may perform rate matching or transmitter side puncturing by not mapping some of the generated symbols to time-frequency resources for the PUCCH/PUSCH resource to ensure the transmitted PUCCH/PUSCH repetition is within the corresponding symbols. Alternatively, UE determines UCI transmission parameter for PUCCH/PUSCH carrying the UCI according to the operation mode determined by the symbols of the PUCCH/PUSCH resource.

In another option, for a UCI transmission parameter associated with operation mode A, if the PUCCH/PUSCH resource is not confined within the UL SB or overlaps with DL SB in a NOSB-FD symbol, the UE may drop or delay the PUCCH/PUSCH, or may perform rate matching or transmitter side puncturing for the PUCCH/PUSCH resource to ensure the transmitted PUCCH/PUSCH is within the corresponding UL SB.

### UCI Transmission Parameter Determination for Multiple UCIs With Same or Different Priorities

A UE may be configured with multiple PUCCHs for different UCI types, e.g., PUCCH for HARQ-ACK, PUCCH for CSI, PUCCH for SR, etc. Furthermore, a UE may be configured with multiple PUCCH configuration for different priorities, e.g., one PUCCH configuration for low priority (LP, priority index 0) for eMBB traffic, and one PUCCH configuration for high priority (HP, priority index 1) for URLLC traffic.

For single priority, a UE may first perform UCI multiplexing for PUCCH (element A), and perform UCI multiplexing on PUSCH (element B), if any PUSCH overlaps with the PUCCH. If a UE is configured with multiple PUCCH configuration for different priorities, e.g., one PUCCH configuration for LP and one PUCCH configuration for HP, and UE is configured with UCI multiplexing for different priorities (e.g., as defined in Rel-17 for UCI multiplexing for different priorities), UE may first perform UCI multiplexing for PUCCH (element 1-A) and then UCI multiplexing on PUSCH (element 1-B) within same priority, and then, UE performs UCI multiplexing/prioritization for PUCCHs (element 2-A) and PUCCH/PUSCH (element 2-B) between different priorities. Alternatively, UE may first perform UCI multiplexing for PUCCH (element 1-A) and then UCI multiplexing on PUSCH (element 1-B) for LP, and then, UE performs UCI prioritization for different priorities (element 2′-X) before or after UCI multiplexing for PUCCH (element 2′-A) and PUSCH for HP (element 2′-B), e.g., as defined in Rel-16.

It is noted that, if there is no PUSCH overlapping with a PUCCH, UE may not actually perform element B/element 1-B/element 2-B/element 2′-B, but we still include element B/element 1-B/element 2-B/element 2′-B as one element of a UCI multiplexing/prioritization procedure for completeness.

In another example, a UE may not be configured with multiple PUCCH transmission parameters for different operation modes, and in such a case, the UE may first perform UCI multiplexing based on existing procedure, and then check for any collision between the resulting PUCCH or PUSCH resource with DL symbol or DL sub-band (if configured) or with resources outside of an UL subband in a NOSB-FD symbol after UCI multiplexing procedure, e.g., after element B for single priority case or after element 2-B or element 2′-B for multiple priories case. Alternatively, UE checks the collision between PUCCH or PUSCH resource with DL symbol or DL sub-band before or after UCI multiplexing procedure.

If gNB configures multiple UCI transmission parameters for different operation modes, in the following, multiplexing procedure, operation mode determination for UCI transmission parameter on PUCCH, and checking for any collision between PUCCH and DL symbol or DL sub-band (if configured) or with resources outside of an UL subband in a NOSB-FD symbol are provided.

In a first embodiment, the operation mode for UCI transmission parameter, e.g. PUCCH transmission parameter is separately determined for each PUCCH. In a PUCCH slot, UE performs UCI multiplexing/prioritization for PUCCHs regardless of operation mode. For a group of overlapped PUCCHs, PUCCHs with different operation mode can be multiplexed or dropped according to pre-defined rule. In one option, whether to drop or multiplex a PUCCH is determined according to UCI type or priority as in Rel-15/16/17, regardless of operation mode. In another option, whether to drop or multiplex a PUCCH is determined according to UCI type or priority (e.g., low priority (LP)/high priority (HP)) or operation mode. For example, the PUCCH with a specific operation mode is dropped before multiplexing. The specific operation mode is pre-defined or configured by gNB.

For the case of LP and HP UCI multiplexing, when UE performs UCI multiplexing within same priority (element A, or element 1-A, or element 2′-A), for a group of overlapped PUCCHs, if the PUCCHs are with different operation mode, PUCCHs with different operation mode can be multiplexed or dropped according to pre-defined rule. When UE performs UCI multiplexing with different priorities (element 2-A), for a group of overlapped PUCCHs, if the PUCCHs are with different operation mode, PUCCHs with different operation mode can be multiplexed or dropped according to pre-defined rule, e.g., LP PUCCH is dropped before multiplexing. The operation mode for a resultant PUCCH for UCI multiplexing is determined according to one or more of:
(1) The operation mode for resultant PUCCH may be configured by higher-layer signaling (e.g., RRC, MAC-CE, etc.).

In one example, the operation mode for resultant PUCCH for UCI multiplexing for same priority can be configured separately for each priority. In another example, the operation mode for resultant PUCCH for UCI multiplexing for same priority and different priorities can be configured separately.
(2) If at least one of overlapped PUCCHs is associated with a specific operation mode, the resultant PUCCH is associated with the specific operation mode. The specific operation mode is pre-defined or configured by gNB.

In one example, the specific operation mode for each priority can be separately configured.

In another example, the specific operation mode for UCI multiplexing for same priority and different priority can be separately configured.
(3) The operation mode for resultant PUCCH is determined by the operation mode associated with the time unit in which the resultant PUCCH resource locates.
(4) If the resultant PUCCH is a PUCCH resource for a certain UCI type, the resultant PUCCH is associated with the operation mode associated with PUCCH resource for the certain UCI type.

For example, if at least one PUCCH of overlapped PUCCHs is HARQ-ACK PUCCH for dynamic PDSCH, the resultant PUCCH is a PUCCH resource for HARQ-ACK for dynamic PDSCH. Then, the operation mode for resultant PUCCH is same as operation mode for HARQ-ACK PUCCH for dynamic PDSCH.
(5) If the resultant PUCCH is for UCI multiplexing between priorities (element 2-A), the resultant PUCCH is associated with the operation mode associated with PUCCH resource for a certain priority, e.g., HP PUCCH.
(6) If at least one of overlapped PUCCHs is HARQ-ACK PUCCH for dynamic PDSCH, the resultant PUCCH is associated with the operation mode for the HARQ-ACK PUCCH for dynamic PDSCH.
(7) If at least one of PUCCH within a PUCCH slot is HARQ-ACK PUCCH, the resultant PUCCH is associated with the operation mode for the HARQ-ACK PUCCH.

In one option, if operation mode for overlapped PUCCHs is the same, the operation mode for resultant PUCCH is same as PUCCHs before multiplexing, otherwise, at least one of (1)˜(7) applies. In another option, at least one of (1)˜(7) applies, regardless of same or different operation mode for overlapped PUCCHs.

In a second embodiment, the operation mode for UCI transmission parameter is separately determined for each PUCCH. In a PUCCH slot, UE separately performs multiplexing/prioritization between PUCCHs within each operation mode. When UE performs multiplexing/prioritization within an operation mode, any resultant PUCCH is also associated with the same operation mode.

In one option, UE does not expect a PUCCH with one operation mode overlaps with another PUCCH with another operation mode, after UE finishes multiplexing/prioritization between PUCCHs within same operation mode.

In another option, a PUCCH with one operation mode may overlap with another PUCCH with another operation mode, after UE completes multiplexing/prioritization between PUCCHs within same operation mode. Then, UE resolves collisions between PUCCHs with different operation mode. In one example, when UE resolves collisions between PUCCHs with different operation mode, PUCCH with a specific operation mode is dropped. In another example, PUCCHs with different operation mode can be multiplexed or dropped according to pre-defined rule.

For the case of LP and HP UCI multiplexing, in one option, for each operation mode, UE first performs multiplexing/prioritization between PUCCHs within same priority and secondly performs multiplexing/prioritization between PUCCHs with different priorities within same operation mode, and then, UE does not expect any PUCCH with different operation mode overlaps. Alternatively, if the PUCCH with different operation mode overlaps, after the processing for each operation mode, UE processes PUCCHs with different operation mode. UE first performs multiplexing/prioritization between PUCCHs within same priority and secondly performs multiplexing/prioritization between PUCCHs with different priorities for different operation mode. The operation mode for a resultant PUCCH for UCI multiplexing could be determined according to mechanisms in first embodiments. In another option, within each priority, UE first performs multiplexing/prioritization between PUCCHs within same operation mode and secondly performs multiplexing/prioritization between PUCCHs with different operation mode, if overlapping between different operation mode is allowed. And then, for different priorities, UE first performs multiplexing/prioritization between PUCCHs within same operation mode and secondly performs multiplexing/prioritization between PUCCHs with different operation mode, if overlapping between different operation mode is allowed.

In a third embodiment, the operation mode for UCI transmission parameter is commonly determined for each PUCCH within a PUCCH slot. The operation mode is determined according to one or more of:
(1) The operation mode is configured by higher-layer.

If the operation mode for PUCCHs within a PUCCH slot is different, the configured operation mode is applied to all PUCCHs within the PUCCH slot. If the operation mode is same for all PUCCHs within a PUCCH slot, the operation mode is determined by each PUCCH.
(2) If at least one of PUCCH within a PUCCH slot is associated with a specific operation mode, all PUCCHs within the PUCCH slot are associated with the specific operation mode.

The specific operation mode is pre-defined, e.g., operation mode A. Alternatively, the specific operation mode is configured by gNB.
(3) If at least one of PUCCH within a PUCCH slot is HARQ-ACK PUCCH for dynamic PDSCH, the operation mode for the HARQ-ACK PUCCH for dynamic PDSCH applies to all PUCCHs within the PUCCH slot.
(4) If at least one of PUCCH within a PUCCH slot is HARQ-ACK PUCCH, the operation mode for the HARQ-ACK PUCCH applies to all PUCCHs within the PUCCH slot.

In case of HARQ-ACK PUCCH overriding, the operation mode for HARQ-ACK PUCCH is determined by the indication in last DL assignment, if any. Alternatively, UE does not expect different operation mode indicated by different DL assignments for HARQ-ACKs in same PUCCH.
(5) If at least one of PUCCH within a PUCCH slot is HARQ-ACK PUCCH with PUCCH resource other than n1PUCCH-AN, the operation mode for the HARQ-ACK PUCCH applies to all PUCCHs within the PUCCH slot.

If there is only HARQ-ACK PUCCH with PUCCH resource configured by n1PUCCH-AN, and if there is CSI PUCCH resource, the operation mode for CSI PUCCH applies to all PUCCHs within the PUCCH slot.
(6) If there are one or more PUCCH resources for CSI feedback and no HARQ-ACK PUCCH, the operation mode for a PUCCH resource with lowest index applies to all PUCCHs within the PUCCH slot.

In this embodiment, in one option, the same operation mode is assumed for any intermediate or final resultant PUCCH after UCI multiplexing/prioritization procedure. In another option, the operation mode for any intermediate or final resultant PUCCH after UCI multiplexing/prioritization procedure may be different from PUCCHs before UCI multiplexing/prioritization. In another option, the same operation mode is assumed for any intermediate or final resultant PUCCH after UCI multiplexing/prioritization procedure for same priority (element A, element 1-A, or element 2′-A), while any intermediate or final resultant PUCCH after UCI multiplexing/prioritization for different priorities (element 2-A) may be different from PUCCHs before UCI multiplexing/prioritization. In case of different operation mode, in one example, some PUCCHs would be dropped before multiplexing, in another example, PUCCHs can be multiplexed.

In a fourth embodiment, the operation mode for UCI transmission parameter is commonly determined for each PUCCH within a PUCCH slot with same priority (element A, element 1-A, or element 2′-A). The mechanisms in third embodiment can be applied within each priority. For the configured operation mode or specific operation mode, gNB may separately configure the operation mode for each priority.

Since the operation mode for PUCCHs with different priorities are determined separately, the operation mode for PUCCHs with different priorities can be different. In one option, for UCI multiplexing with different priorities (element 2-A), if the PUCCHs with different priorities are with different operation mode, an operation mode is determined and applied to all PUCCHs. For example, the operation mode is the operation mode for HP PUCCHs. In another option, if the PUCCHs with different priorities are with different operation mode, for a group of overlapped PUCCHs with different priorities, LP PUCCH is dropped, alternatively, LP and HP PUCCH is multiplexed/prioritized regardless of operation mode according to pre-defined rule. Then, the operation mode for a resultant PUCCH for UCI multiplexing with different priorities is determined according to one or more of:
(1) The operation mode for resultant PUCCH is configured by higher-layer.
(2) If at least one of overlapped PUCCHs with different priorities is associated with a specific operation mode, the resultant PUCCH is associated with the specific operation mode.
(3) The operation mode for resultant PUCCH is determined by the operation mode associated with the time unit in which the resultant PUCCH resource locates.
(4) If the resultant PUCCH is a PUCCH resource for a certain UCI type, the resultant PUCCH is associated with the operation mode associated with PUCCH resource for the certain UCI type.
(5) The resultant PUCCH is associated with the operation mode associated with PUCCH resource for a certain priority, e.g., HP PUCCH.
(6) If at least one of overlapped PUCCHs is HARQ-ACK PUCCH for dynamic PDSCH, the resultant PUCCH is associated with the operation mode for the HARQ-ACK PUCCH for dynamic PDSCH.
(7) If at least one of PUCCH within a PUCCH slot is HARQ-ACK PUCCH, the resultant PUCCH is associated with the operation mode for the HARQ-ACK PUCCH.

In a fifth embodiment, the operation mode for UCI transmission parameter is determined for resultant PUCCH after UCI multiplexing/prioritization procedure.

For example, assuming same time domain resource is configured for PUCCHs for different operation mode, UE does not need to determine operation mode for each PUCCH before UCI multiplexing/prioritization procedure. If a UE is only configured with single priority, UE performances UCI multiplexing procedure as in Rel-15. If a UE is configured with multiple priorities, UE performances UCI multiplexing/prioritization procedure for different priorities as in Rel-16 or Rel-17 per configuration. After UCI multiplexing/prioritization procedure (e.g., after element-A for Rel-15, or after element 2-A for Rel-17), for each resultant PUCCH, the operation mode is determined according to solutions in ‘UCI transmission parameter determination according to operation mode’ section above.

In a sixth embodiment, the operation mode for UCI transmission parameter is determined for PUCCH after UCI multiplexing within the same priority (after element A, or after element 1-A, or after element 2′-A). In other words, the operation mode for resultant PUCCH for each priority (before resolving collisions between PUCCHs with different priorities) is separately determined. Since the operation mode for resultant PUCCHs for each priority are determined separately, the operation mode for PUCCHs with different priorities can be different. In one option, when UE performs UCI multiplexing for different priorities (element 2-A), if the PUCCHs with different priorities are with different operation mode, an operation mode is determined and applied to all PUCCHs. The operation mode is the operation mode for HP PUCCHs. In another option, if the PUCCHs with different priorities are with different operation mode, for a group of overlapped PUCCHs with different priorities, LP PUCCH is dropped, alternatively, LP and HP PUCCH is multiplexed/prioritized regardless of operation mode according to pre-defined rule. Then, the operation mode for a resultant PUCCH for UCI multiplexing with different priorities is determined according to mechanisms in third embodiment.

For above embodiments, if a PUCCH is not aligned with the operation mode determined by the symbols of the PUCCH resource, or the PUCCH associated with operation mode A is not confined within the UL SB in a NOSB-FD symbol, UE may drop/delay/rate matching/puncture a PUCCH as described in ‘UCI transmission parameter determination according to operation mode’ section above. In one option, UE only checks potential mis-alignment between the PUCCH resource and the determined operation mode for PUCCHs after UCI multiplexing/prioritization procedure. In another option, UE only checks potential mis-alignment between the PUCCH resource and the determined operation mode for PUCCHs after UCI multiplexing/prioritization procedure within same priority and PUCCHs after UCI multiplexing/prioritization procedure among different priorities. In another option, UE checks any PUCCH during (intermediate PUCCH) or after UCI multiplexing/prioritization. In another option, UE checks any PUCCH before or after UCI multiplexing/prioritization. In another option, UE checks any PUCCH before or after UCI multiplexing/prioritization, and any intermediate PUCCH.

In the following, multiplexing procedure, operation mode determination for UCI transmission parameter on PUSCH, and checking of collisions between PUSCH and DL symbol/DL sub-band (if configured) or PRBs outside of UL subband in a NOSB-FD symbol are provided.

In a seventh embodiment, for single priority, in one option, UE first performs multiplexing/prioritization between PUCCHs regardless of operation mode, and then UE performs multiplexing/prioritization between PUCCH and PUSCH regardless of operation mode. In another option, UE first performs multiplexing/prioritization between PUCCHs and then between PUCCH and PUSCH within same operation mode, UE secondly performs multiplexing/prioritization between PUCCHs for different operation mode, and then between PUCCH and PUSCH for different operation mode. In another option, UE first performs multiplexing/prioritization between PUCCHs with same operation mode and then performs multiplexing/prioritization between PUCCHs with different operation mode, UE secondly performs multiplexing/prioritization between PUCCH and PUSCH with same operation mode and then performs multiplexing/prioritization between PUCCH and PUSCH with different operation mode. In another option, UE first performs multiplexing/prioritization between PUCCHs with same operation mode and then performs multiplexing/prioritization between PUCCHs with different operation mode, and then performs multiplexing/prioritization between PUCCH and PUSCH regardless of operation mode.

For options above, in one example, UE does not expect a PUCCH after UCI multiplexing between PUCCHs with one operation mode overlapping with another PUCCH with another operation mode. Alternatively, such PUCCHs can be overlapped. In another example, UE does not expect a PUCCH after UCI multiplexing between PUCCHs with one operation mode overlapping with a PUSCH with another operation mode. Alternatively, the PUCCH and PUSCH with different operation mode can be overlapped. For such case, UE may multiplex PUCCH with PUSCH, alternatively, UE may drop PUCCH or PUSCH, e.g., always drop PUSCH.

For multiple priorities, e.g., for LP and HP UCI multiplexing, in one option, regardless of operation mode, UE first performs multiplexing/prioritization between PUCCHs within same priority, and then UE performs multiplexing/prioritization between PUCCH and PUSCH within same priority, after that, UE secondly performs multiplexing/prioritization between PUCCHs for different priorities, and then UE performs multiplexing/prioritization between PUCCH and PUSCH for different priorities. In another option, for a priority, UE first performs multiplexing/prioritization between PUCCHs within same operation mode and then performs multiplexing/prioritization between PUCCHs with different operation mode, and then performs multiplexing/prioritization between PUCCH and PUSCH, after that, for different priorities, UE first performs multiplexing/prioritization between PUCCHs within same operation mode and then performs multiplexing/prioritization between PUCCHs with different operation mode, and then performs multiplexing/prioritization between PUCCH and PUSCH. In another option, for a priority, UE first performs multiplexing/prioritization between PUCCHs within same operation mode and then performs multiplexing/prioritization between PUCCH and PUSCH within same operation mode, and then performs multiplexing/prioritization between PUCCHs with different operation mode and then performs multiplexing/prioritization between PUCCH and PUSCH with different operation mode. After that, for different priorities, UE first performs multiplexing/prioritization between PUCCHs within same operation mode and then performs multiplexing/prioritization between PUCCH and PUSCH with same operation mode, and then performs multiplexing/prioritization between PUCCHs with different operation mode and then performs multiplexing/prioritization between PUCCH and PUSCH with different operation mode. In another option, for an operation mode, UE first performs multiplexing/prioritization between PUCCHs within same priority and then performs multiplexing/prioritization between PUCCH and PUSCH within same priority, and then, UE first performs multiplexing/prioritization between PUCCHs with different priorities and then performs multiplexing/prioritization between PUCCH and PUSCH with different priorities. After that, for different operation mode, UE first performs multiplexing/prioritization between PUCCHs within same priority and then performs multiplexing/prioritization between PUCCH and PUSCH within same priority, and then, UE first performs multiplexing/prioritization between PUCCHs with different priorities and then performs multiplexing/prioritization between PUCCH and PUSCH with different priorities. In another option, for an operation mode, UE first performs multiplexing/prioritization between PUCCHs within same priority and then performs multiplexing/prioritization between PUCCHs with different priorities, after that, for different operation modes, UE first performs multiplexing/prioritization between PUCCHs within same priority and then performs multiplexing/prioritization between PUCCHs with different priorities. Then, UE performs multiplexing/prioritization between PUCCH and PUSCH for same priority, and then for different priorities.

For UCI multiplexing on PUSCH with different operation mode, in one option, UE may prioritize to select a PUSCH with same operation mode as PUCCH. In another option, UE may prioritize to select a PUSCH with a specific operation mode, e.g., operation mode B to protect UCI performance. In another option, UE only selects a PUSCH from a set of PUSCHs with same operation mode as PUCCH. In another option, UE only selects a PUSCH from a set of PUSCHs with a specific operation mode. UE may drop PUSCH overlapping with PUCCH and transmit the PUCCH, if UE fails to select a PUSCH from the set of PUSCHs.

In an eighth embodiment, the operation mode for UCI transmission parameter is determined by PUSCH carrying the UCI.

In one option, UE determines the operation mode for PUCCH after or within UCI multiplexing/prioritization for PUCCHs (element A or element 1-A/element 2-A or element 1-A/element 2′-A) according to any of first to sixth embodiments. And UE determines the operation mode for UCI transmission parameter according to PUSCH (element B or element 1-B/element 2-B or element 1-B/element 2′-B), if the UCI is multiplexed onto the PUSCH.

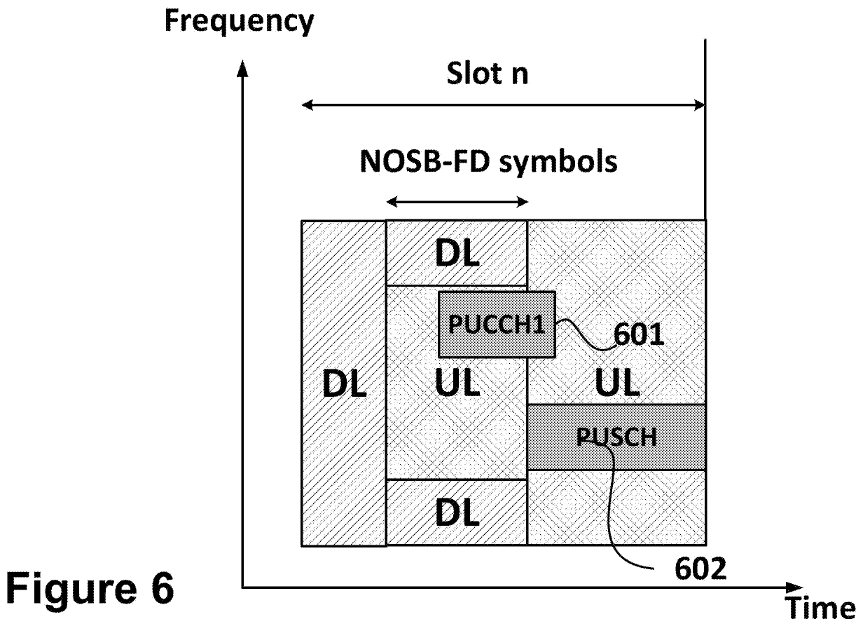

For example in FIG. 6, the resultant PUCCH (PUCCH1 601) after UCI multiplexing between PUCCHs is associated with operation mode A, the PUCCH1 601 overlaps with a PUSCH 602 which is in regular symbols. The PUCCH1 601 is multiplexed with the PUSCH 602. Then, the UCI transmission parameters is determined by operation mode B no matter the PUCCH1 601 is in regular symbol or NOSB-FD symbol.

In another option, UE does not determine the operation mode for PUCCH before the end of UCI multiplexing/prioritization procedure. UE determines the operation mode for UCI transmission parameter at the end of UCI multiplexing/prioritization procedure (after element B or element 2-B, or element 2′-B). For example, for single priority case, after UCI multiplexing/prioritization procedure, if a UCI is to be multiplexed on a PUSCH (element B is the last element), the operation mode for UCI transmission parameter is determined by the PUSCH, if a UCI is to be transmitted by a PUCCH (element A may be considered to be the last element, however embodiments may be described as including element B, because there is no PUSCH overlapping with the PUCCH after element A), the operation mode for UCI transmission parameter is determined by the PUCCH by fourth embodiment above. For the example in FIG. 6, UE does not determine the operation mode for PUCCH1. UE only determines UCI transmission parameter according to PUSCH.

In another option, UE does not determine the operation mode for PUCCH before the end of UCI multiplexing/prioritization procedure within same priority. In other words, if a UE is configured with different priorities, UE determines the operation mode for UCI transmission parameter at the end of UCI multiplexing/prioritization procedure within same priority (after element 1-B or element 2′-B), and UE determines the operation mode for UCI transmission parameter at the end of UCI multiplexing/prioritization procedure for different priorities (after element 2-B).

In a ninth embodiment, the operation mode for UCI transmission parameter is determined by PUCCH before UCI multiplexing on a PUSCH.

UE determines the operation mode for mode for PUCCH after or within UCI multiplexing/prioritization for PUCCHs (element A or element 1-A/element 2-A or element 1-A/element 2′-A) according to any of first to sixth embodiments. And UE determines the operation mode for UCI transmission parameter on PUSCH according to the operation mode for the PUCCH.

For example in FIG. 6, the resultant PUCCH (PUCCH1) after UCI multiplexing between PUCCHs is associated with operation mode A, the UCI transmission parameters is determined by operation mode A no matter the PUSCH carrying the UCI is in regular symbol or not.

For above embodiments, if a UE is configured with multiple priorities, in one option, in element 2-B or after element 2-B, the operation mode for UCI transmission parameters on a PUSCH carrying at least HP UCI is determined by HP PUCCH or HP PUSCH if any. In another option, in element 2-B or after element 2-B, the operation mode for HP UCI transmission parameters on a PUSCH carrying at least the HP UCI is determined by HP PUCCH or HP PUSCH if any. For example, after element 2-B, a LP PUSCH carries HP UCI, UCI transmission parameters for HP UCI is determined by HP PUCCH after element 1. If a HP PUSCH carriers HP UCI and LP UCI, UCI transmission parameters for HP and LP UCI is determined by HP PUSCH. In another option, in element 2-B or after element 2-B, the operation mode for UCI transmission parameters on a PUSCH is determined by the PUSCH. For example, after element 2-B, a LP PUSCH carries HP UCI, UCI transmission parameters for HP UCI is determined by the LP PUSCH.

### PUCCH Transmission Parameter Determination for PUCCH Repetition

If a UE is configured with PUCCH repetition, and the UE is configured with multiple PUCCH transmission parameters for different operation mode, UE determines the PUCCH resource for each repetition according to pre-defined rule.

In one embodiment, if the operation mode for UCI transmission by PUCCH is indicated by gNB, the indicated operation mode applies to all repetitions.

In another embodiment, if the operation mode for UCI transmission by PUCCH is determined by the operation mode associated with the time unit in which PUCCH resource locates, in one option,

the operation mode is determined for each repetition respectively according to the time unit for each repetition. In another option, the operation mode is commonly determined for all repetitions according to the time unit for all repetitions. In one example, the operation mode associated with a time unit spanning multiple repetitions may be determined based on the first symbol of the first repetition within the time unit being a NOSB-FD symbol or a regular (DL/UL/FL) symbol. In another example, the operation mode associated with a time unit for 1^{st} repetition is applied to all repetitions. In another example, the operation mode A (for NOSB-FD symbols) may be assumed by a UE for all repetitions of a PUCCH if any repetition may overlap with a NOSB-FD symbol.

If the operation mode is determined for each repetition respectively, in one option, if the operation mode is different for repetitions, UE only transmits some of PUCCH repetitions with same operation mode, e.g., with a specific operation mode. In another option, if the number of available REs for each repetition/coding rate for each repetition is different, UE only transmits some of PUCCH repetitions with same coding rate/number of available REs. For example, UE only transmits first repetition, or repetitions with same coding rate/number of available REs as first repetition, or repetitions with lowest coding rate. Alternatively, UE does not expect repetitions with different coding rate/number of available REs. This option can be applied with single or multiple operation modes.

In one embodiment, for a UCI transmission parameter associated with an operation mode, if a PUCCH repetition is not aligned with the operation mode determined by the symbols of the PUCCH resource, UE may drop or delay a PUCCH repetition. For a UCI transmission parameter associated with operation mode A, if a PUCCH repetition is not confined within the UL SB in a NOSB-FD symbol, UE may drop or delay the PUCCH repetition. Rate matching or puncture is undesirable, because different coding rate for different PUCCH repetition adds complexity for combining, at least for some channel coding mechanism. In one option, whether rate matching can be applied is configured by gNB. In another option, whether rate matching can be applied depends on channel coding mechanism/PUCCH payload, e.g., it can be applied for Reed-Muller (RM) code but not Polar code. In another option, whether rate matching can be applied depend on whether same coding rate is achieved for all repetitions. For example, if the number of available REs after rate matching is the same for all repetitions, rate matching can be applied.

### SPS HARQ-ACK Defer

SPS HARQ-ACK deferral can be configured to reduce undesirable drop of SPS HARQ-ACK PUCCH, which collides with DL symbols or DL sub-band. If gNB does not configure NOSB-FD based duplex, for SPS HARQ-ACK defer, for the determination of valid symbols in initial and target PUCCH slot, a symbol is not counted as valid symbol, if the symbol overlaps with semi-static DL symbols, SSB and symbols indicated by pdcch-ConfigSIB1 in MIB for a CORESET for Type0-PDCCH CSS set

If gNB configures NOSB-FD based duplex, the invalid symbol can be determined as one of options below.

In one embodiment, for SPS HARQ-ACK defer, for the determination of valid symbols in initial and target PUCCH slot, a symbol is an invalid symbol:
if at least one of the symbols of a PUCCH resource overlaps with an NOSB-FD symbol and all the PRBs allocated for the PUCCH transmission are not included within the UL subband, or.
if at least one of the symbols of a PUCCH resource overlaps with an NOSB-FD symbol and at least one PRB allocated for the PUCCH transmission falls within a DL subband if a DL subband is indicated explicitly or implicitly for a NOSB-FD symbol, or
if at least one of the symbols of a PUCCH resource overlaps with a DL symbol indicated by tdd-UL-DLConfigurationCommon or tdd-UL-DL-ConfigurationDedicated if provided, or a symbol of an SS/PBCH block, or
if at least one of the symbols of a PUCCH resource overlaps with a DL symbol indicated as part of CORESET for Type-0 PDCCH configured in MIB.

In one embodiment, for SPS HARQ-ACK defer, for the determination of valid symbols in initial and target PUCCH slot, a symbol is an invalid symbol:
if at least one of the symbols of a PUCCH resource overlaps with an NOSB-FD symbol and all the PRBs allocated for the PUCCH transmission are not included within the UL subband, or
if at least one of the symbols of a PUCCH resource overlaps with an NOSB-FD symbol and at least one PRB allocated for the PUCCH transmission falls within a DL subband if a DL subband is indicated explicitly or implicitly for a NOSB-FD symbol, or
if at least one of the symbols of a PUCCH resource overlaps with a semi-static DL symbol.

In one option, the semi-static DL symbol is a DL symbol indicated by tdd-UL-DL-ConfigurationDedicated if provided, or a DL symbol indicated by tdd-UL-DLConfigurationCommon and the symbol is not indicated as NOSB-FD symbol by dedicated higher-layer signaling. In another option, the semi-static DL symbol is tdd-UL-DLConfigurationCommon or tdd-UL-DL-ConfigurationDedicated if provided.

For above embodiments, the PUCCH resource is resultant PUCCH resource after UCI multiplexing/prioritization. In other words, UE first performs UCI multiplexing/prioritization, if UE would be transmitting SPS HARQ-ACK using the PUCCH with SPS PUCCH resource, e.g., SPS-PUCCH-AN-List-r16 or n1PUCCH-AN, and the PUCCH resource consists of invalid symbol, the SPS HARQ-ACK configured for deferral is deferred.

gNB can configure SPS HARQ-ACK deferral based on NOSB-FD or not. For example, even if gNB configures NOSB-FD based duplex, gNB can still configure SPS HARQ-ACK deferral as if NOSB-FD duplex is not configured. gNB can configure SPS HARQ-ACK deferral mechanism for each SPS configuration, or for each configured BWP, or for each configured carrier, or for a UE. If gNB configures SPS HARQ-ACK deferral as if NOSB-FD duplex is not configured, and if UE would be transmitting SPS HARQ-ACK with SPS PUCCH resource which collides with DL sub-band, UE drops the PUCCH without deferral. Alternatively, UE does not expect such collision.

If UE is configured with multiple sets of UCI transmission parameters for different operation mode, gNB can configure SPS HARQ-ACK deferral mechanism (based on NOSB-FD or not) for each operation mode. In one option, UE determines SPS HARQ-ACK deferral mechanism according to the operation mode associated with the resultant SPS HARQ-ACK PUCCH in initial slot. For example, if in initial slot n, the resultant SPS HARQ-ACK PUCCH is associated with an operation mode with SPS HARQ-ACK deferral mechanism A, UE uses the mechanism A to determine SPS HARQ-ACK deferral. When UE checks next slot n+1, the resultant SPS HARQ-ACK PUCCH is associated with an operation mode with SPS HARQ-ACK deferral mechanism B, UE still uses SPS HARQ-ACK deferral mechanism A to determine SPS HARQ-ACK deferral. In another option, UE determines SPS HARQ-ACK deferral mechanism according to the operation mode associated with the resultant SPS HARQ-ACK PUCCH in every checked slot. For example, if in initial slot n, the resultant SPS HARQ-ACK PUCCH is associated with an operation mode with SPS HARQ-ACK deferral mechanism A, UE uses the mechanism A to determine SPS HARQ-ACK deferral, and when UE checks next slot n+1, the resultant SPS HARQ-ACK PUCCH is associated with an operation mode with SPS HARQ-ACK deferral mechanism B, UE uses SPS HARQ-ACK deferral mechanism B to determine SPS HARQ-ACK deferral.

### Systems and Implementations

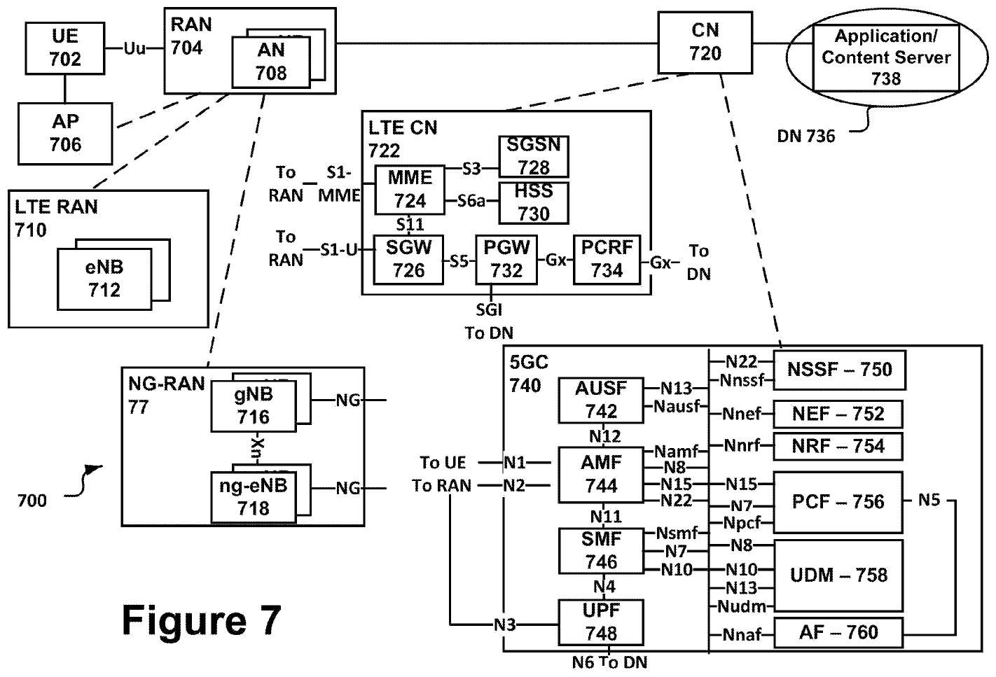

FIGS. 7-10 illustrate various systems, devices, and components that may implement aspects of disclosed embodiments.

FIG. 7 illustrates a network 700 in accordance with various embodiments. The network 700 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 700 may include a UE 702, which may include any mobile or non-mobile computing device designed to communicate with a RAN 704 via an over-the-air connection. The UE 702 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 700 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 702 may additionally communicate with an AP 706 via an over-the-air connection. The AP 706 may manage a WLAN connection, which may serve to offload some/all network traffic from the RAN 704. The connection between the UE 702 and the AP 706 may be consistent with any IEEE 802.11 protocol, wherein the AP 706 could be a wireless fidelity (Wi-Fi®) router. In some embodiments, the UE 702, RAN 704, and AP 706 may utilize cellular-WLAN aggregation (for example, LWA/LWIP). Cellular-WLAN aggregation may involve the UE 702 being configured by the RAN 704 to utilize both cellular radio resources and WLAN resources.

The RAN 704 may include one or more access nodes, for example, AN 708. AN 708 may terminate air-interface protocols for the UE 702 by providing access stratum protocols including RRC, PDCP, RLC, MAC, and L1 protocols. In this manner, the AN 708 may enable data/voice connectivity between CN 720 and the UE 702. In some embodiments, the AN 708 may be implemented in a discrete device or as one or more software entities running on server computers as part of, for example, a virtual network, which may be referred to as a CRAN or virtual baseband unit pool. The AN 708 be referred to as a BS, gNB, RAN node, eNB, ng-eNB, NodeB, RSU, TRxP, TRP, etc. The AN 708 may be a macrocell base station or a low power base station for providing femtocells, picocells or other like cells having smaller coverage areas, smaller user capacity, or higher bandwidth compared to macrocells.

In embodiments in which the RAN 704 includes a plurality of ANs, they may be coupled with one another via an X2 interface (if the RAN 704 is an LTE RAN) or an Xn interface (if the RAN 704 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 704 may each manage one or more cells, cell groups, component carriers, etc. to provide the UE 702 with an air interface for network access. The UE 702 may be simultaneously connected with a plurality of cells provided by the same or different ANs of the RAN 704. For example, the UE 702 and RAN 704 may use carrier aggregation to allow the UE 702 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 704 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 702 or AN 708 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 704 may be an LTE RAN 710 with eNBs, for example, eNB 712. The LTE RAN 710 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 704 may be an NG-RAN 714 with gNBs, for example, gNB 716, or ng-eNBs, for example, ng-eNB 718. The gNB 716 may connect with 5G-enabled UEs using a 5G NR interface. The gNB 716 may connect with a 5G core through an NG interface, which may include an N2 interface or an N3 interface. The ng-eNB 718 may also connect with the 5G core through an NG interface, but may connect with a UE via an LTE air interface. The gNB 716 and the ng-eNB 718 may connect with each other over an Xn interface.

In some embodiments, the NG interface may be split into two parts, an NG user plane (NG-U) interface, which carries traffic data between the nodes of the NG-RAN 714 and a UPF 748 (e.g., N3 interface), and an NG control plane (NG-C) interface, which is a signaling interface between the nodes of the NG-RAN 714 and an AMF 744 (e.g., N2 interface).

The NG-RAN 714 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FRI bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 702 can be configured with multiple BWPs where each BWP configuration has a different SCS. When a BWP change is indicated to the UE 702, the SCS of the transmission is changed as well. Another use case example of BWP is related to power saving. In particular, multiple BWPs can be configured for the UE 702 with different amount of frequency resources (for example, PRBs) to support data transmission under different traffic loading scenarios. A BWP containing a smaller number of PRBs can be used for data transmission with small traffic load while allowing power saving at the UE 702 and in some cases at the gNB 716. A BWP containing a larger number of PRBs can be used for scenarios with higher traffic load.

The RAN 704 is communicatively coupled to CN 720 that includes network elements to provide various functions to support data and telecommunications services to customers/subscribers (for example, users of UE 702). The components of the CN 720 may be implemented in one physical node or separate physical nodes. In some embodiments, NFV may be utilized to virtualize any or all of the functions provided by the network elements of the CN 720 onto physical compute/storage resources in servers, switches, etc. A logical instantiation of the CN 720 may be referred to as a network slice, and a logical instantiation of a portion of the CN 720 may be referred to as a network sub-slice.

In some embodiments, the CN 720 may be an LTE CN 722, which may also be referred to as an EPC. The LTE CN 722 may include MME 724, SGW 726, SGSN 728, HSS 730, PGW 732, and PCRF 734 coupled with one another over interfaces (or “reference points”) as shown. Functions of the elements of the LTE CN 722 may be briefly introduced as follows.

The MME 724 may implement mobility management functions to track a current location of the UE 702 to facilitate paging, bearer activation/deactivation, handovers, gateway selection, authentication, etc.

The SGW 726 may terminate an SI interface toward the RAN and route data packets between the RAN and the LTE CN 722. The SGW 726 may be a local mobility anchor point for inter-RAN node handovers and also may provide an anchor for inter-3GPP mobility. Other responsibilities may include lawful intercept, charging, and some policy enforcement.

The SGSN 728 may track a location of the UE 702 and perform security functions and access control. In addition, the SGSN 728 may perform inter-EPC node signaling for mobility between different RAT networks; PDN and S-GW selection as specified by MME 724; MME selection for handovers; etc. The S3 reference point between the MME 724 and the SGSN 728 may enable user and bearer information exchange for inter-3GPP access network mobility in idle/active states.

The HSS 730 may include a database for network users, including subscription-related information to support the network entities' handling of communication sessions. The HSS 730 can provide support for routing/roaming, authentication, authorization, naming/addressing resolution, location dependencies, etc. An S6a reference point between the HSS 730 and the MME 724 may enable transfer of subscription and authentication data for authenticating/authorizing user access to the LTE CN 720.

The PGW 732 may terminate an SGi interface toward a data network (DN) 736 that may include an application/content server 738. The PGW 732 may route data packets between the LTE CN 722 and the data network 736. The PGW 732 may be coupled with the SGW 726 by an S5 reference point to facilitate user plane tunneling and tunnel management. The PGW 732 may further include a node for policy enforcement and charging data collection (for example, PCEF). Additionally, the SGi reference point between the PGW 732 and the data network 736 may be an operator external public, a private PDN, or an intra-operator packet data network, for example, for provision of IMS services. The PGW 732 may be coupled with a PCRF 734 via a Gx reference point.

The PCRF 734 is the policy and charging control element of the LTE CN 722. The PCRF 734 may be communicatively coupled to the app/content server 738 to determine appropriate QoS and charging parameters for service flows. The PCRF 732 may provision associated rules into a PCEF (via Gx reference point) with appropriate TFT and QCI.

In some embodiments, the CN 720 may be a 5GC 740. The 5GC 740 may include an AUSF 742, AMF 744, SMF 746, UPF 748, NSSF 750, NEF 752, NRF 754, PCF 756, UDM 758, and AF 760 coupled with one another over interfaces (or “reference points”) as shown. Functions of the elements of the 5GC 740 may be briefly introduced as follows.

The AUSF 742 may store data for authentication of UE 702 and handle authentication-related functionality. The AUSF 742 may facilitate a common authentication framework for various access types. In addition to communicating with other elements of the 5GC 740 over reference points as shown, the AUSF 742 may exhibit an Nausf service-based interface.

The AMF 744 may allow other functions of the 5GC 740 to communicate with the UE 702 and the RAN 704 and to subscribe to notifications about mobility events with respect to the UE 702. The AMF 744 may be responsible for registration management (for example, for registering UE 702), connection management, reachability management, mobility management, lawful interception of AMF-related events, and access authentication and authorization. The AMF 744 may provide transport for SM messages between the UE 702 and the SMF 746, and act as a transparent proxy for routing SM messages. AMF 744 may also provide transport for SMS messages between UE 702 and an SMSF. AMF 744 may interact with the AUSF 742 and the UE 702 to perform various security anchor and context management functions. Furthermore, AMF 744 may be a termination point of a RAN CP interface, which may include or be an N2 reference point between the RAN 704 and the AMF 744; and the AMF 744 may be a termination point of NAS (N1) signaling, and perform NAS ciphering and integrity protection. AMF 744 may also support NAS signaling with the UE 702 over an N3 IWF interface.

The SMF 746 may be responsible for SM (for example, session establishment, tunnel management between UPF 748 and AN 708); UE IP address allocation and management (including optional authorization); selection and control of UP function; configuring traffic steering at UPF 748 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 744 over N2 to AN 708; and determining SSC mode of a session. SM may refer to management of a PDU session, and a PDU session or “session” may refer to a PDU connectivity service that provides or enables the exchange of PDUs between the UE 702 and the data network 736.

The UPF 748 may act as an anchor point for intra-RAT and inter-RAT mobility, an external PDU session point of interconnect to data network 736, and a branching point to support multi-homed PDU session. The UPF 748 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 748 may include an uplink classifier to support routing traffic flows to a data network.

The NSSF 750 may select a set of network slice instances serving the UE 702. The NSSF 750 may also determine allowed NSSAI and the mapping to the subscribed S-NSSAIs, if needed. The NSSF 750 may also determine the AMF set to be used to serve the UE 702, or a list of candidate AMFs based on a suitable configuration and possibly by querying the NRF 754. The selection of a set of network slice instances for the UE 702 may be triggered by the AMF 744 with which the UE 702 is registered by interacting with the NSSF 750, which may lead to a change of AMF. The NSSF 750 may interact with the AMF 744 via an N22 reference point; and may communicate with another NSSF in a visited network via an N31 reference point (not shown). Additionally, the NSSF 750 may exhibit an Nnssf service-based interface.

The NEF 752 may securely expose services and capabilities provided by 3GPP network functions for third party, internal exposure/re-exposure, AFs (e.g., AF 760), edge computing or fog computing systems, etc. In such embodiments, the NEF 752 may authenticate, authorize, or throttle the AFs. NEF 752 may also translate information exchanged with the AF 760 and information exchanged with internal network functions. For example, the NEF 752 may translate between an AF-Service-Identifier and an internal 5GC information. NEF 752 may also receive information from other NFs based on exposed capabilities of other NFs. This information may be stored at the NEF 752 as structured data, or at a data storage NF using standardized interfaces. The stored information can then be re-exposed by the NEF 752 to other NFs and AFs, or used for other purposes such as analytics. Additionally, the NEF 752 may exhibit an Nnef service-based interface.

The NRF 754 may support service discovery functions, receive NF discovery requests from NF instances, and provide the information of the discovered NF instances to the NF instances. NRF 754 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 754 may exhibit the Nnrf service-based interface.

The PCF 756 may provide policy rules to control plane functions to enforce them, and may also support unified policy framework to govern network behavior. The PCF 756 may also implement a front end to access subscription information relevant for policy decisions in a UDR of the UDM 758. In addition to communicating with functions over reference points as shown, the PCF 756 exhibit an Npcf service-based interface.

The UDM 758 may handle subscription-related information to support the network entities' handling of communication sessions, and may store subscription data of UE 702. For example, subscription data may be communicated via an N8 reference point between the UDM 758 and the AMF 744. The UDM 758 may include two parts, an application front end and a UDR. The UDR may store subscription data and policy data for the UDM 758 and the PCF 756, and/or structured data for exposure and application data (including PFDs for application detection, application request information for multiple UEs 702) for the NEF 752. The Nudr service-based interface may be exhibited by the UDR 221 to allow the UDM 758, PCF 756, and NEF 752 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 758 may exhibit the Nudm service-based interface.

The AF 760 may provide application influence on traffic routing, provide access to NEF, and interact with the policy framework for policy control.

In some embodiments, the 5GC 740 may enable edge computing by selecting operator/3rd party services to be geographically close to a point that the UE 702 is attached to the network. This may reduce latency and load on the network. To provide edge-computing implementations, the 5GC 740 may select a UPF 748 close to the UE 702 and execute traffic steering from the UPF 748 to data network 736 via the N6 interface. This may be based on the UE subscription data, UE location, and information provided by the AF 760. In this way, the AF 760 may influence UPF (re) selection and traffic routing. Based on operator deployment, when AF 760 is considered to be a trusted entity, the network operator may permit AF 760 to interact directly with relevant NFs. Additionally, the AF 760 may exhibit an Naf service-based interface.

The data network 736 may represent various network operator services, Internet access, or third party services that may be provided by one or more servers including, for example, application/content server 738.

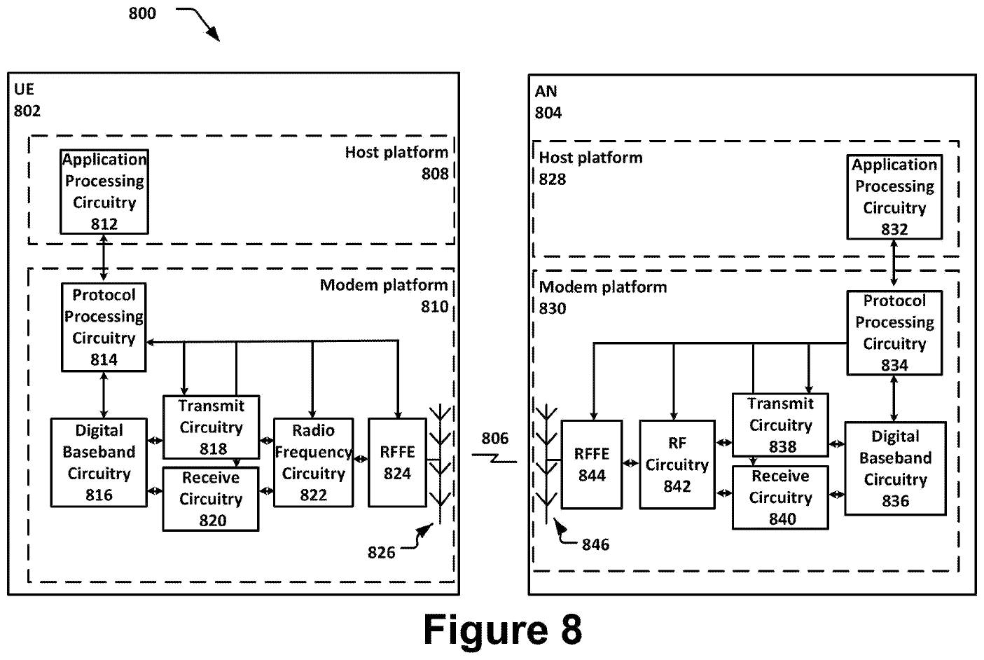

FIG. 8 schematically illustrates a wireless network 800 in accordance with various embodiments. The wireless network 800 may include a UE 802 in wireless communication with an AN 804. The UE 802 and AN 804 may be similar to, and substantially interchangeable with, like-named components described elsewhere herein.

The UE 802 may be communicatively coupled with the AN 804 via connection 806. The connection 806 is illustrated as an air interface to enable communicative coupling, and can be consistent with cellular communications protocols such as an LTE protocol or a 5G NR protocol operating at mm Wave or sub-6 GHz frequencies.

The UE 802 may include a host platform 808 coupled with a modem platform 810. The host platform 808 may include application processing circuitry 812, which may be coupled with protocol processing circuitry 814 of the modem platform 810. The application processing circuitry 812 may run various applications for the UE 802 that source/sink application data. The application processing circuitry 812 may further implement one or more layer operations to transmit/receive application data to/from a data network. These layer operations may include transport (for example UDP) and Internet (for example, IP) operations

The protocol processing circuitry 814 may implement one or more of layer operations to facilitate transmission or reception of data over the connection 806. The layer operations implemented by the protocol processing circuitry 814 may include, for example, MAC, RLC, PDCP, RRC and NAS operations.

The modem platform 810 may further include digital baseband circuitry 816 that may implement one or more layer operations that are “below” layer operations performed by the protocol processing circuitry 814 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 810 may further include transmit circuitry 818, receive circuitry 820, RF circuitry 822, and RF front end (RFFE) 824, which may include or connect to one or more antenna panels 826. Briefly, the transmit circuitry 818 may include a digital-to-analog converter, mixer, intermediate frequency (IF) components, etc.; the receive circuitry 820 may include an analog-to-digital converter, mixer, IF components, etc.; the RF circuitry 822 may include a low-noise amplifier, a power amplifier, power tracking components, etc.; RFFE 824 may include filters (for example, surface/bulk acoustic wave filters), switches, antenna tuners, beamforming components (for example, phase-array antenna components), etc. The selection and arrangement of the components of the transmit circuitry 818, receive circuitry 820, RF circuitry 822, RFFE 824, and antenna panels 826 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 814 may include one or more instances of control circuitry (not shown) to provide control functions for the transmit/receive components.

A UE reception may be established by and via the antenna panels 826, RFFE 824, RF circuitry 822, receive circuitry 820, digital baseband circuitry 816, and protocol processing circuitry 814. In some embodiments, the antenna panels 826 may receive a transmission from the AN 804 by receive-beamforming signals received by a plurality of antennas/antenna elements of the one or more antenna panels 826.

A UE transmission may be established by and via the protocol processing circuitry 814, digital baseband circuitry 816, transmit circuitry 818, RF circuitry 822, RFFE 824, and antenna panels 826. In some embodiments, the transmit components of the UE 804 may apply a spatial filter to the data to be transmitted to form a transmit beam emitted by the antenna elements of the antenna panels 826.

Similar to the UE 802, the AN 804 may include a host platform 828 coupled with a modem platform 830. The host platform 828 may include application processing circuitry 832 coupled with protocol processing circuitry 834 of the modem platform 830. The modem platform may further include digital baseband circuitry 836, transmit circuitry 838, receive circuitry 840, RF circuitry 842, RFFE circuitry 844, and antenna panels 846. The components of the AN 804 may be similar to and substantially interchangeable with like-named components of the UE 802. In addition to performing data transmission/reception as described above, the components of the AN 808 may perform various logical functions that include, for example, RNC functions such as radio bearer management, uplink and downlink dynamic radio resource management, and data packet scheduling.

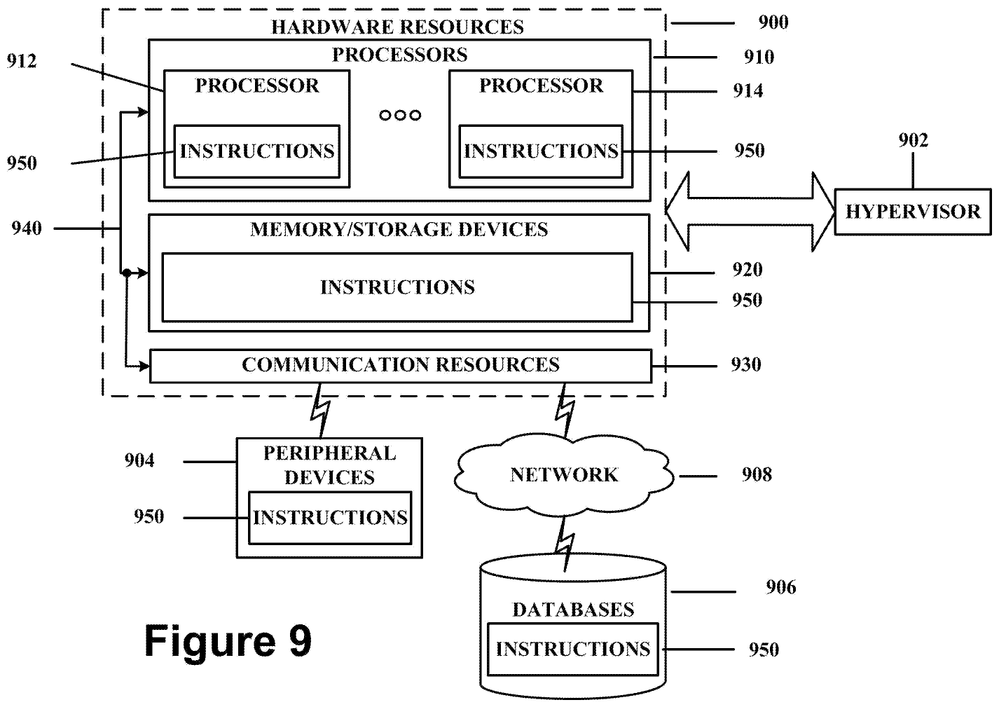

FIG. 9 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 900 including one or more processors (or processor cores) 910, one or more memory/storage devices 920, and one or more communication resources 930, each of which may be communicatively coupled via a bus 940 or other interface circuitry. For embodiments where node virtualization (e.g., NFV) is utilized, a hypervisor 902 may be executed to provide an execution environment for one or more network slices/sub-slices to utilize the hardware resources 900.

The processors 910 may include, for example, a processor 912 and a processor 914. The processors 910 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 920 may include main memory, disk storage, or any suitable combination thereof. The memory/storage devices 920 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 930 may include interconnection or network interface controllers, components, or other suitable devices to communicate with one or more peripheral devices 904 or one or more databases 906 or other network elements via a network 908. For example, the communication resources 930 may include wired communication components (e.g., for coupling via USB, Ethernet, etc.), cellular communication components, NFC components, Bluetooth® (or Bluetooth® Low Energy) components, Wi-Fi® components, and other communication components.

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources 900 from any combination of the peripheral devices 904 or the databases 906. Accordingly, the memory of processors 910, the memory/storage devices 920, the peripheral devices 904, and the databases 906 are examples of computer-readable and machine-readable media.

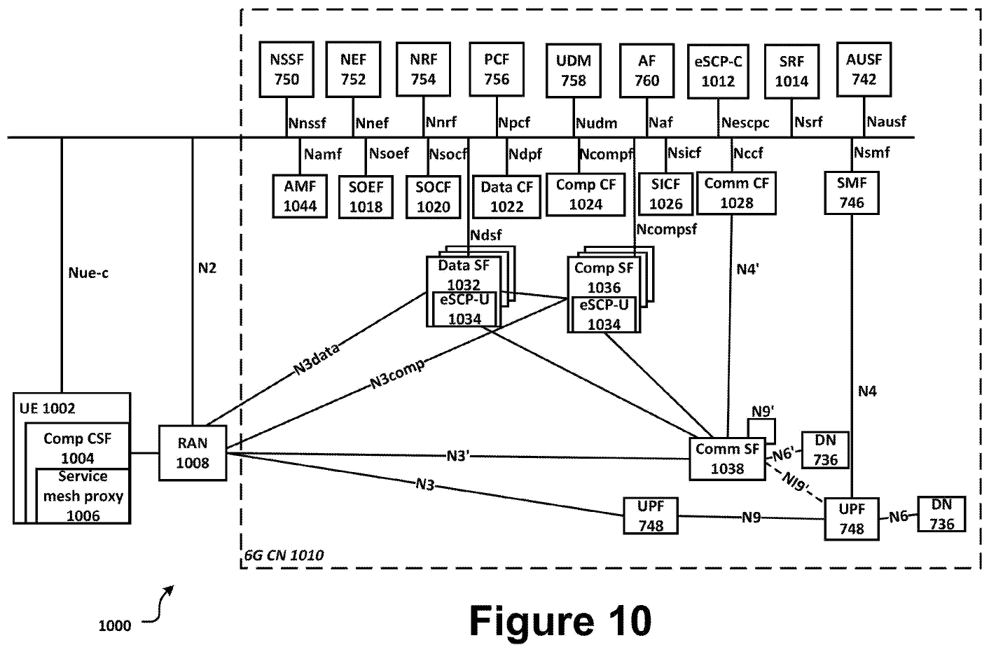

FIG. 10 illustrates a network 1000 in accordance with various embodiments. The network 1000 may operate in a matter consistent with 3GPP technical specifications or technical reports for 6G systems. In some embodiments, the network 1000 may operate concurrently with network 700. For example, in some embodiments, the network 1000 may share one or more frequency or bandwidth resources with network 700. As one specific example, a UE (e.g., UE 1002) may be configured to operate in both network 1000 and network 700. Such configuration may be based on a UE including circuitry configured for communication with frequency and bandwidth resources of both networks 700 and 1000. In general, several elements of network 1000 may share one or more characteristics with elements of network 700. For the sake of brevity and clarity, such elements may not be repeated in the description of network 1000.

The network 1000 may include a UE 1002, which may include any mobile or non-mobile computing device designed to communicate with a RAN 1008 via an over-the-air connection. The UE 1002 may be similar to, for example, UE 702. The UE 1002 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 10, in some embodiments the network 1000 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 10, the UE 1002 may be communicatively coupled with an AP such as AP 706 as described with respect to FIG. 7. Additionally, although not specifically shown in FIG. 10, in some embodiments the RAN 1008 may include one or more ANss such as AN 708 as described with respect to FIG. 7. The RAN 1008 and/or the AN of the RAN 1008 may be referred to as a base station (BS), a RAN node, or using some other term or name.

The UE 1002 and the RAN 1008 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 1008 may allow for communication between the UE 1002 and a 6G core network (CN) 1010. Specifically, the RAN 1008 may facilitate the transmission and reception of data between the UE 1002 and the 6G CN 1010. The 6G CN 1010 may include various functions such as NSSF 750, NEF 752, NRF 754, PCF 756, UDM 758, AF 760, SMF 746, and AUSF 742. The 6G CN 1010 may additional include UPF 748 and DN 736 as shown in FIG. 10. Additionally, the RAN 1008 may include various additional functions that are in addition to, or alternative to, functions of a legacy cellular network such as a 4G or 5G network. Two such functions may include a Compute Control Function (Comp CF) 1024 and a Compute Service Function (Comp SF) 1036. The Comp CF 1024 and the Comp SF 1036 may be parts or functions of the Computing Service Plane. Comp CF 1024 may be a control plane function that provides functionalities such as management of the Comp SF 1036, computing task context generation and management (e.g., create, read, modify, delete), interaction with the underlying computing infrastructure for computing resource management, etc. Comp SF 1036 may be a user plane function that serves as the gateway to interface computing service users (such as UE 1002) and computing nodes behind a Comp SF instance. Some functionalities of the Comp SF 1036 may include: parse computing service data received from users to compute tasks executable by computing nodes; hold service mesh ingress gateway or service API gateway; service and charging policies enforcement; performance monitoring and telemetry collection, etc. In some embodiments, a Comp SF 1036 instance may serve as the user plane gateway for a cluster of computing nodes. A Comp CF 1024 instance may control one or more Comp SF 1036 instances.

Two other such functions may include a Communication Control Function (Comm CF) 1028 and a Communication Service Function (Comm SF) 1038, which may be parts of the Communication Service Plane. The Comm CF 1028 may be the control plane function for managing the Comm SF 1038, communication sessions creation/configuration/releasing, and managing communication session context. The Comm SF 1038 may be a user plane function for data transport. Comm CF 1028 and Comm SF 1038 may be considered as upgrades of SMF 746 and UPF 748, which were described with respect to a 5G system in FIG. 7. The upgrades provided by the Comm CF 1028 and the Comm SF 1038 may enable service-aware transport. For legacy (e.g., 4G or 5G) data transport, SMF 746 and UPF 748 may still be used.

Two other such functions may include a Data Control Function (Data CF) 1022 and Data Service Function (Data SF) 1032 may be parts of the Data Service Plane. Data CF 1022 may be a control plane function and provides functionalities such as Data SF 1032 management, Data service creation/configuration/releasing, Data service context management, etc. Data SF 1032 may be a user plane function and serve as the gateway between data service users (such as UE 1002 and the various functions of the 6G CN 1010) and data service endpoints behind the gateway. Specific functionalities may include include: parse data service user data and forward to corresponding data service endpoints, generate charging data, report data service status.

Another such function may be the Service Orchestration and Chaining Function (SOCF) 1020, which may discover, orchestrate and chain up communication/computing/data services provided by functions in the network. Upon receiving service requests from users, SOCF 1020 may interact with one or more of Comp CF 1024, Comm CF 1028, and Data CF 1022 to identify Comp SF 1036, Comm SF 1038, and Data SF 1032 instances, configure service resources, and generate the service chain, which could contain multiple Comp SF 1036, Comm SF 1038, and Data SF 1032 instances and their associated computing endpoints. Workload processing and data movement may then be conducted within the generated service chain. The SOCF 1020 may also responsible for maintaining, updating, and releasing a created service chain.

Another such function may be the service registration function (SRF) 1014, which may act as a registry for system services provided in the user plane such as services provided by service endpoints behind Comp SF 1036 and Data SF 1032 gateways and services provided by the UE 1002. The SRF 1014 may be considered a counterpart of NRF 754, which may act as the registry for network functions.

Other such functions may include an evolved service communication proxy (eSCP) and service infrastructure control function (SICF) 1026, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 1012 and eSCP-U 1034, for control plane service communication proxy and user plane service communication proxy, respectively. The SICF 1026 may control and configure eCSP instances in terms of service traffic routing policies, access rules, load balancing configurations, performance monitoring, etc.

Another such function is the AMF 1044. The AMF 1044 may be similar to 744, but with additional functionality. Specifically, the AMF 1044 may include potential functional repartition, such as move the message forwarding functionality from the AMF 1044 to the RAN 1008.

Another such function is the service orchestration exposure function (SOEF) 1018. The SOEF may be configured to expose service orchestration and chaining services to external users such as applications.

The UE 1002 may include an additional function that is referred to as a computing client service function (comp CSF) 1004. The comp CSF 1004 may have both the control plane functionalities and user plane functionalities, and may interact with corresponding network side functions such as SOCF 1020, Comp CF 1024, Comp SF 1036, Data CF 1022, and/or Data SF 1032 for service discovery, request/response, compute task workload exchange, etc. The Comp CSF 1004 may also work with network side functions to decide on whether a computing task should be run on the UE 1002, the RAN 1008, and/or an element of the 6G CN 1010.

The UE 1002 and/or the Comp CSF 1004 may include a service mesh proxy 1006. The service mesh proxy 1006 may act as a proxy for service-to-service communication in the user plane. Capabilities of the service mesh proxy 1006 may include one or more of addressing, security, load balancing, etc.

### Example Procedures

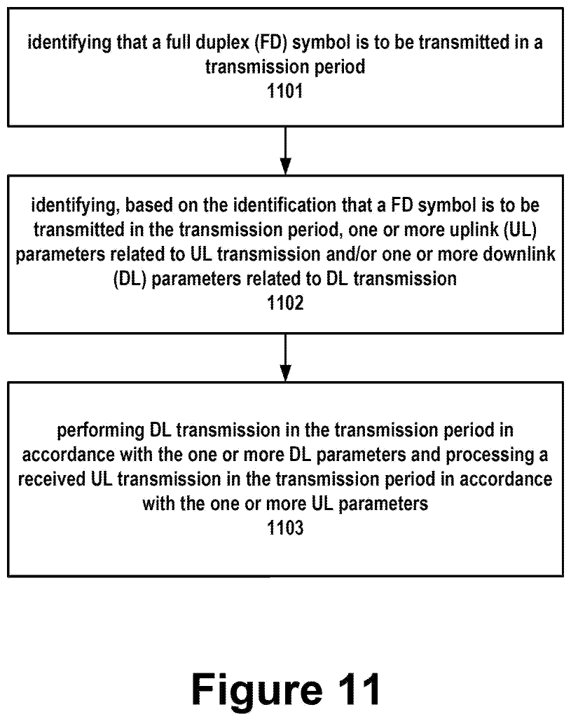

In some embodiments, the electronic device(s), network(s), system(s), chip(s) or component(s), or portions or implementations thereof, of FIGS. 7-10, or some other figure herein, may be configured to perform one or more processes, techniques, or methods as described herein, or portions thereof. One such process is depicted in FIG. 11. In embodiments, the process of FIG. 11 may be performed by a fifth generation (5G) base station (gNB), one or more elements of a gNB, and/or one or more electronic devices that include and/or implement a gNB. The process may include, at 1101 identifying that a full duplex (FD) symbol is to be transmitted in a transmission period; identifying, at 1102 based on the identification that a FD symbol is to be transmitted in the transmission period, one or more uplink (UL) parameters related to UL transmission and/or one or more downlink (DL) parameters related to DL transmission; and performing, at 1103, DL transmission in the transmission period in accordance with the one or more DL parameters and processing a received UL transmission in the transmission period in accordance with the one or more UL parameters.

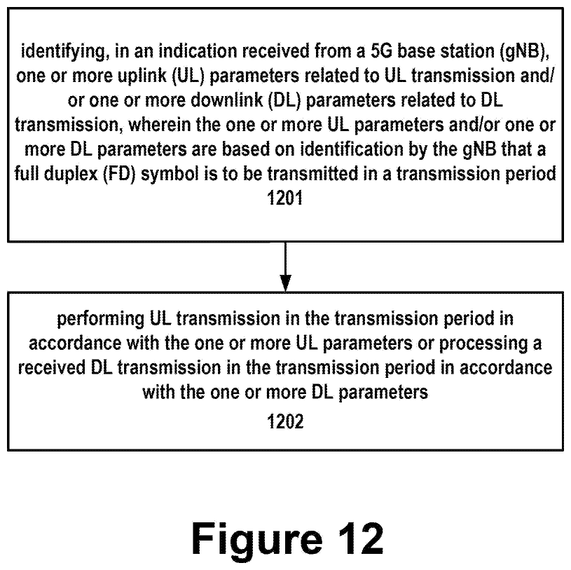

Another such process is depicted in FIG. 12. In embodiments, the process of FIG. 12 may be performed by a user equipment (UE) in a fifth generation (5G) network, one or more elements of a UE, and/or one or more electronic devices that include and/or implement a UE. The process may include: identifying, at 1201 in an indication received from a 5G base station (gNB), one or more uplink (UL) parameters related to UL transmission and/or one or more downlink (DL) parameters related to DL transmission, wherein the one or more UL parameters and/or one or more DL parameters are based on identification by the gNB that a full duplex (FD) symbol is to be transmitted in a transmission period; and performing, at 1202, UL transmission in the transmission period in accordance with the one or more UL parameters or processing a received DL transmission in the transmission period in accordance with the one or more DL parameters.

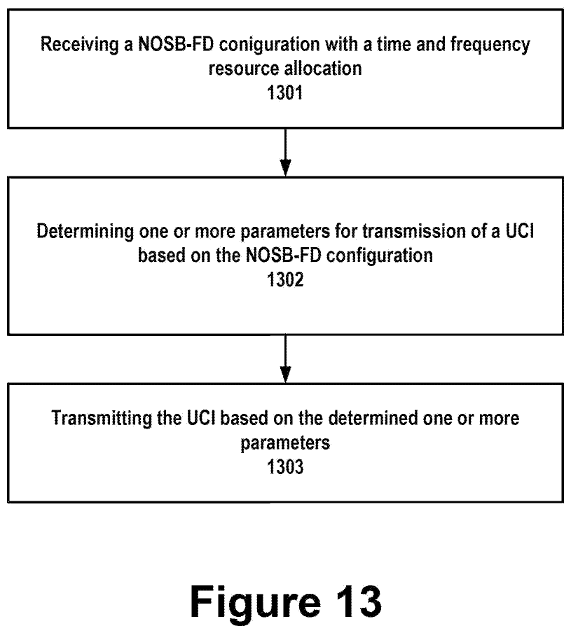

Another such process is depicted in FIG. 13. In embodiments, the process of FIG. 13 may include or relate to a method to be performed by a user equipment (UE), one or more elements of a UE, and/or one or more electronic devices that include and/or implement a UE, the method comprising: receiving, at 1301, a Non-Overlapping Sub-Band Full Duplex (NOSB-FD) configuration with a time and frequency resource allocation; determining, at 1302, one or more parameters for transmission of an uplink control information (UCI) based on the NOSB-FD configuration; and transmitting, at 1303, the UCI based on the determined one or more parameters.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include the system and methods of multiple operation modes for DL or UL transmission in duplex operation comprising
configuring, by a gNB, UL and DL resource within the serving cell or BWP bandwidth for different symbols.
receiving, by a UE, the UL and DL resource configuration,
receiving or transmitting, by a UE, the DL or UL channels/signals, according to the configuration of the DL or UL channels/signals and/or the DCI scheduling the DL or UL channels/signals.

Example 2 may include the method of example 1, and/or some other example herein, wherein the transmission parameters in the configuration of the DL or UL transmission includes one or more of:
DL or UL BWP
Frequency domain resource information
MCS table
Transform precoding (i.e. DFT-s-OFDM or OFDM waveform)
Power control parameters
Rate matching pattern for PDSCH
Invalid symbol pattern for PUSCH
Spatial Information
Transmit power scaling for DL signals and channels relative to a reference

Example 3 may include the method of example 1, and/or some other example herein, wherein different operation modes for a DL or UL transmission are introduced to identify the operations in a NOSB-FD symbol and/or a regular symbol.

Example 4 may include the method of example 3, and/or some other example herein, wherein a UE expect that any UL transmission is contained within the intersection of the PRBs of active UL BWP in an UL symbol and the PRBs within the UL subband (or UL PRBs) in a NOSB-FD symbol

Example 5 may include the method of example 3, and/or some other example herein, wherein An operation mode for the DL or UL transmission is determined based on a time unit that includes the allocated symbols of the DL or UL transmission.

Example 6 may include the method of example 5, and/or some other example herein, wherein the time unit can include all symbols in a slot, a PUCCH slot, or multiple slots used by the DL or UL transmission

Example 7 may include the method of example 5, and/or some other example herein, wherein the time unit is included exactly the allocated symbols of the DL or UL transmission in a slot, a PUCCH slot, or multiple slots used by the DL or UL transmission

Example 8 may include the method of example 5, and/or some other example herein, wherein if at least one symbol of a time unit is a NOSB-FD symbol, a UE uses operation mode A in the time unit. Otherwise, the UE uses operation mode B in the time unit.

Example 9 may include the method of example 5, and/or some other example herein, wherein for a given time unit, the operation mode for the time unit is determined based on the first symbol of the time unit being a NOSB-FD symbol or a regular (DL/UL/FL) symbol.

Example 10 may include the method of example 5, and/or some other example herein, wherein if all symbols of a time unit are NOSB-FD symbols, a UE uses operation mode A in the time unit; if all symbols of a time unit are regular symbols, a UE uses operation mode B in the time unit.

Example 11 may include the method of examples 3-10, and/or some other example herein, wherein in the configuration of a DL or UL transmission, a UE is configured with the transmission parameters that are associated with one or multiple operation modes, and the UE uses the transmission parameters of the determined operation mode to perform the DL or UL transmission.

Example 12 may include the method of example 11, and/or some other example herein, wherein the DL or UL transmission in different time units may be associated with same or different operation modes.

Example 13 may include the method of example 11, and/or some other example herein, wherein for a DL or UL transmission, an operation mode is determined across multiple time units of the DL or UL transmission.

Example 14 may include the method of example 13, and/or some other example herein, wherein UE expects that the DL or UL transmission in the multiple time units use the same operation mode.

Example 15 may include the method of example 13, and/or some other example herein, wherein an operation mode is determined based on the first of the multiple time units, and UE preforms the DL or UL transmission in any of the multiple time units with the same operation mode.

Example 16 may include the method of example 13, and/or some other example herein, wherein an operation mode is determined based on the first of the multiple time units, and UE performs the DL or UL transmission following the same operation mode in all the multiple time units

Example 17 may include the method of example 13, and/or some other example herein, wherein an operation mode is determined based on the first of the multiple time units, and a slot is not considered as available slot if the allocated symbols in the slot is associated with a different operation mode.

Example 18 may include the method of example 11, and/or some other example herein, wherein for a DL or UL transmission, UE expect that every time unit of the DL or UL transmission must use the same operation mode.

Example 19 may include the method of examples 3-10, and/or some other example herein, wherein in a configuration of a DL or UL transmission, a UE is configured with corresponding parameters that are associated with an operation mode.

Example 20 may include the method of examples 11 or 19, and/or some other example herein, wherein an operation mode is indicated by a DCI that schedules the DL or UL transmission

Example 21 may include the method of examples 18 or 19, and/or some other example herein, wherein UE expects that the configured or indicated operation mode is aligned with the operation mode determined in any time unit that includes the allocated symbols of the DL or UL transmission.

Example 22 may include the method of examples 18 or 19, and/or some other example herein, wherein if a different operation mode is determined in a time unit of the DL or UL transmission, the UE drops the DL or UL transmission in the time unit, or drop the DL or UL transmission entirety.

Example 23 may include the method of examples 18 or 19, and/or some other example herein, wherein if the DL or UL transmission is configured with repetitions, a slot is not considered as available slot if a different operation mode is determined in the slot of the DL or UL transmission.

Example 24 may include the method of examples 18 or 19, and/or some other example herein, wherein UE receives or transmits the DL or UL transmission based on the configured or indicated operation mode.

Example 25 includes a method to be performed by a fifth generation (5G) base station (gNB), wherein the method comprises:
identifying that a full duplex (FD) symbol is to be transmitted in a transmission period;
identifying, based on the identification that a FD symbol is to be transmitted in the transmission period, one or more uplink (UL) parameters related to UL transmission and/or one or more downlink (DL) parameters related to DL transmission; and
performing DL transmission in the transmission period in accordance with the one or more DL parameters and processing a received UL transmission in the transmission period in accordance with the one or more UL parameters.

Example 26 includes the method of example 25, and/or some other example herein, wherein the FD symbol is a non-overlapping sub-band FD (NOSB-FD) symbol.

Example 27 includes the method of any of examples 25-26, and/or some other example herein, wherein the FD symbol is a symbol capable of simultaneous UL and DL transmission in the same symbol.

Example 28 includes the method of any of examples 25-27, and/or some other example herein, wherein the transmission period is a slot or group of slots.

Example 29 includes the method of any of examples 25-28, and/or some other example herein, wherein the UL parameters or DL parameters include one or more of the parameters provided in Example 2.

Example 30 includes a method to be performed by a user equipment (UE) in a fifth generation (5G) network, wherein the method comprises:
identifying, in an indication received from a 5G base station (gNB), one or more uplink (UL) parameters related to UL transmission and/or one or more downlink (DL) parameters related to DL transmission, wherein the one or more UL parameters and/or one or more DL parameters are based on identification by the gNB that a full duplex (FD) symbol is to be transmitted in a transmission period; and
performing UL transmission in the transmission period in accordance with the one or more UL parameters or processing a received DL transmission in the transmission period in accordance with the one or more DL parameters.

Example 31 includes the method of example 30, and/or some other example herein, wherein the FD symbol is a non-overlapping sub-band FD (NOSB-FD) symbol.

Example 32 includes the method of any of examples 30-31, and/or some other example herein, wherein the FD symbol is a symbol capable of simultaneous UL and DL transmission in the same symbol.

Example 33 includes the method of any of examples 30-32, and/or some other example herein, wherein the transmission period is a slot or group of slots.

Example 34 includes the method of any of examples 30-33, and/or some other example herein, wherein the UL parameters or DL parameters include one or more of the parameters provided in Example 2.

Example 1B may include a method of wireless communication for a fifth generation (5G) or new radio (NR) system, the method comprising:
receiving, by a UE from a gNB, a Non-Overlapping Sub-Band Full Duplex (NOSB-FD) configuration with time and frequency resource allocation; and
determining, by the UE, a UCI transmission parameter in accordance with the NOSB-FD configuration.

Example 2B may include the method of example 1B or some other example herein, wherein the UCI transmission parameter includes PUCCH transmission parameter and UCI parameters on PUSCH.

Example 3B may include the method of example 1B or some other example herein, wherein the UCI transmission parameter is separately configured and determined for different operation mode.

Example 4B may include the method of examples 2B and 3B or some other example herein, wherein different operation modes are introduced to identify the operations in a NOSB-FD symbol and/or a regular symbol.

Example 5B may include the method of examples 2B and 3B or some other example herein, wherein the operation mode associated with the UCI transmission parameter is determined based on symbols in one or multiple PUCCH slots, or symbols of a PUCCH resource, or symbols of a PUSCH, or indication by gNB.

Example 6B may include the method of examples 2B and 3B or some other example herein, wherein the operation mode for a PUCCH resource is determined before UCI multiplexing, or before and after UCI multiplexing, or after UCI multiplexing.

Example 7B may include the method of example 6B or some other example herein, wherein the operation mode for a PUCCH resource is separately determined, or jointly determined by a set of PUCCH resources.

Example 8B may include the method of examples 6B and 7B or some other example herein, wherein UCI multiplexing is performed within each operation mode respectively.

Example 9B may include the method of example 8B or some other example herein, wherein UCI multiplexing is further performed between different operation modes, after UCI multiplexing within each operation mode.

Example 10B may include the method of example 8B or some other example herein, wherein UCI multiplexing is performed within same priority and then between different priorities with same operation mode.

Example 11B may include the method of examples 9B and 10B or some other example herein, wherein UCI multiplexing is performed within same priority and then between different priorities with different operation mode, after UCI multiplexing within each operation mode.

Example 12B may include the method of examples 6B and 7B or some other example herein, wherein UCI multiplexing is performed regardless of operation mode.

Example 13B may include the method of example 5B or some other example herein, wherein UCI transmission parameter is determined according to PUSCH.

Example 14B may include the method of example 13B or some other example herein, wherein UCI multiplexing is performed within each operation mode for PUCCHs and/or PUCCH with PUSCH.

Example 15B may include the method of example 14B or some other example herein, wherein UCI multiplexing is further performed between different operation modes for PUCCHs and/or PUCCH with PUSCH, after UCI multiplexing within each operation mode.

Example 16B may include the method of example 13B or some other example herein, wherein the operation mode for UCI parameter on the PUSCH is determined after UCI multiplexing, or after UCI multiplexing for PUCCHs.

Example 17B may include the method of example 5B or some other example herein, wherein the operation mode for each PUCCH repetition is separately determined or jointly determined by all repetitions.

Example 18B may include the method of example 1B or some other example herein, wherein UCI transmission parameter includes SPS HARQ-ACK deferral determination.

Example 19B may include the method of example 18B or some other example herein, wherein the SPS HARQ-ACK defers, if a resultant PUCCH after UCI multiplexing is SPS HARQ-ACK PUCCH resource which collides with regular DL symbol, or collides with DL sub- and in NOSB-FD symbol.

Example 20B may include a method of a user equipment (UE), the method comprising:
receiving a Non-Overlapping Sub-Band Full Duplex (NOSB-FD) configuration with a time and frequency resource allocation;
determining one or more parameters for transmission of an uplink control information (UCI) based on the NOSB-FD configuration; and
transmitting the UCI based on the determined one or more parameters.

Example 21B may include the method of example 20B or some other example herein, wherein the one or more parameters include one or more PUCCH transmission parameters and/or UCI parameters on PUSCH.

Example 22B may include the method of example 20B, 21B, or some other example herein, wherein the one or more parameters are separately configured and determined for different operation modes.

Example 1C includes a base station comprising: one or more processors; and one or more non-transitory computer-readable media comprising instructions that, upon execution of the instructions by the one or more processors, are to cause the base station to: identify that a full duplex (FD) symbol is to be transmitted in a transmission period; identify, based on the identification that a FD symbol is to be transmitted in the transmission period, one or more transmission parameters related to a unidirectional transmission; and facilitate wireless unidirectional transmission based on the one or more transmission parameters; wherein the FD symbol is a symbol capable of simultaneous uplink (UL) and downlink (DL) transmission in the same symbol.

Example 2C includes the base station of example 1C, and/or some other example herein, wherein the FD symbol is a non-overlapping sub-band FD (NOSB-FD) symbol.

Example 3C includes the base station of example 1C, and/or some other example herein, wherein the one or more transmission parameters include one or more DL transmission parameters or one or more UL transmission parameters.

Example 4C includes the base station of any of examples 1C-3C, and/or some other example herein, wherein the one or more transmission parameters are applied to all occasions in the transmission period.

Example 5C includes the base station of any of examples 1C-3C, and/or some other example herein, wherein: the one or more transmission parameters are first one or more transmission parameters; the first one or more transmission parameters are applied to a first occasion in the transmission period; and second one or more transmission parameters are applied to a second occasion in the transmission period.

Example 6C includes the base station of any of examples 1C-3C, and/or some other example herein, wherein occasions of the unidirectional transmission in the transmission period are within FD symbols and not within non-FD symbols.

Example 7C includes the base station of any of examples 1C-3C, and/or some other example herein, wherein occasions of the unidirectional transmission in the transmission period are within FD symbols and within non-FD symbols.

Example 8C includes a user equipment (UE) comprising: one or more processors; and one or more non-transitory computer-readable media comprising instructions that, upon execution of the instructions by the one or more processors, are to cause the UE to: identify, in an indication received from a base station, one or more transmission parameters related to a unidirectional wireless transmission, wherein the one or more transmission parameters are based on identification by the base station that a full duplex (FD) symbol is to be transmitted by the base station in a transmission period, wherein the FD symbol is a symbol capable of simultaneous UL and DL transmission in the same symbol; and facilitate the unidirectional wireless transmission based on the one or more transmission parameters.

Example 9C includes the UE of example 8C, and/or some other example herein, wherein the FD symbol is a non-overlapping sub-band FD (NOSB-FD) symbol.

Example 10C includes the UE of example 8C, and/or some other example herein, wherein the one or more transmission parameters include one or more DL transmission parameters or one or more UL transmission parameters.

Example 11C includes the UE of any of examples 8C-10C, and/or some other example herein, wherein the one or more transmission parameters are applied to all occasions in the transmission period.

Example 12C includes the UE of any of examples 8C-10C, and/or some other example herein, wherein: the one or more transmission parameters are first one or more transmission parameters; the first one or more transmission parameters are applied to a first occasion in the transmission period; and second one or more transmission parameters are applied to a second occasion in the transmission period.

Example 13C includes the UE of any of examples 8C-10C, and/or some other example herein, wherein occasions of the unidirectional transmission in the transmission period are within FD symbols and not within non-FD symbols.

Example 14C includes the UE of any of examples 8C-10C, and/or some other example herein, wherein occasions of the unidirectional transmission in the transmission period are within FD symbols and within non-FD symbols.

Example 15C includes one or more non-transitory computer-readable media comprising instructions that, upon execution of the instructions by one or more processors of a user equipment (UE), are to cause the UE to: identify an indication of a Non-Overlapping Sub-Band Full Duplex (NOSB-FD) configuration, wherein the NOSB-FD configuration includes a time and frequency resource allocation; determine, based on the NOSB-FD configuration, one or more parameters for transmission an uplink control information (UCI); and transmit the UCI based on the determined one or more parameters.

Example 16C includes the one or more non-transitory computer-readable media of example 15C, and/or some other example herein, wherein the one or more parameters include one or more physical uplink control channel (PUCCH) transmission parameters.

Example 17C includes the one or more non-transitory computer-readable media of example 15C, and/or some other example herein, wherein the one or more parameters include one or more physical uplink shared channel (PUSCH) parameters.

Example 18C includes the one or more non-transitory computer-readable media of example 17C, and/or some other example herein, wherein the UCI is to be transmitted on the PUSCH.

Example 19C includes the one or more non-transitory computer-readable media of any of examples 15C-18C, and/or some other example herein, wherein the one or more parameters are based on which of a plurality of operation modes are to be used the transmission of the UCI.

Example 20C includes the one or more non-transitory computer-readable media of any of examples 15C-18C, and/or some other example herein, wherein the plurality of operation modes include an operation mode A that refers to transmission in NOSB-FD symbols, and an operation mode B that refers to transmission in symbols that are not NOSB-FD symbols.

Example Z01 may include an apparatus comprising means to perform one or more elements of a method described in or related to any of examples 1-20C, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-20C, or any other method or process described herein.

Example Z03 may include an apparatus comprising logic, modules, or circuitry to perform one or more elements of a method described in or related to any of examples 1-20C, or any other method or process described herein.

Example Z04 may include a method, technique, or process as described in or related to any of examples 1-20C, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-20C, or portions thereof.

Example Z06 may include a signal as described in or related to any of examples 1-20C, or portions or parts thereof.

Example Z07 may include a datagram, packet, frame, segment, protocol data unit (PDU), or message as described in or related to any of examples 1-20C, or portions or parts thereof, or otherwise described in the present disclosure.

Example Z08 may include a signal encoded with data as described in or related to any of examples 1-20C, or portions or parts thereof, or otherwise described in the present disclosure.

Example Z09 may include a signal encoded with a datagram, packet, frame, segment, protocol data unit (PDU), or message as described in or related to any of examples 1-20C, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-20C, or portions thereof.

Example Z11 may include a computer program comprising instructions, wherein execution of the program by a processing element is to cause the processing element to carry out the method, techniques, or process as described in or related to any of examples 1-20C, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### ABBREVIATIONS

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

3GPP Third Generation Partnership Project
4G Fourth Generation
5G Fifth Generation
5GC 5G Core network
AC Application Client
ACR Application Context Relocation
ACK Acknowledgement
ACID Application Client Identification
AF Application Function
AM Acknowledged Mode
AMBRAggregate Maximum Bit Rate
AMF Access and Mobility Management Function
AN Access Network
ANR Automatic Neighbour Relation
AOA Angle of Arrival
AP Application Protocol, Antenna Port, Access Point
API Application Programming Interface
APN Access Point Name
ARP Allocation and Retention Priority
ARQ Automatic Repeat Request
AS Access Stratum
ASP Application Service Provider
ASN.1 Abstract Syntax Notation One
AUSF Authentication Server Function
AWGN Additive White Gaussian Noise
BAP Backhaul Adaptation Protocol
BCH Broadcast Channel
BER Bit Error Ratio
BFD Beam Failure Detection
BLER Block Error Rate
BPSK Binary Phase Shift Keying
BRAS Broadband Remote Access Server
BSS Business Support System
BS Base Station
BSR Buffer Status Report
BW Bandwidth
BWP Bandwidth Part
C-RNTI Cell Radio Network Temporary Identity
CA Carrier Aggregation, Certification Authority
CAPEX CAPital EXpenditure
CBRA Contention Based Random Access
CC Component Carrier, Country Code, Cryptographic Checksum
CCA Clear Channel Assessment
CCE Control Channel Element
CCCH Common Control Channel
CE Coverage Enhancement
CDM Content Delivery Network
CDMA Code-Division Multiple Access
CDR Charging Data Request
CDR Charging Data Response
CFRA Contention Free Random Access
CG Cell Group
CGF Charging Gateway Function
CHF Charging Function
CI Cell Identity
CID Cell-ID (e.g., positioning method)
CIM Common Information Model
CIR Carrier to Interference Ratio
CK Cipher Key
CM Connection Management, Conditional Mandatory
CMAS Commercial Mobile Alert Service
CMD Command
CMS Cloud Management System
CO Conditional Optional
CoMP Coordinated Multi-Point
CORESET Control Resource Set
COTS Commercial Off-The-Shelf
CP Control Plane, Cyclic Prefix, Connection Point
CPD Connection Point Descriptor
CPE Customer Premise Equipment
CPICHCommon Pilot Channel
CQI Channel Quality Indicator
CPU CSI processing unit, Central Processing Unit
C/R Command/Response field bit
CRAN Cloud Radio Access Network, Cloud RAN
CRB Common Resource Block
CRC Cyclic Redundancy Check
CRI Channel-State Information Resource Indicator,
CSI-RS Resource Indicator
C-RNTI Cell RNTI
CS Circuit Switched
CSCF call session control function
CSAR Cloud Service Archive
CSI Channel-State Information
CSI-IM CSI Interference Measurement
CSI-RS CSI Reference Signal
CSI-RSRP CSI reference signal received power
CSI-RSRQ CSI reference signal received quality
CSI-SINR CSI signal-to-noise and interference ratio
CSMA Carrier Sense Multiple Access
CSMA/CA CSMA with collision avoidance
CSS Common Search Space, Cell-specific Search Space
CTF Charging Trigger Function
CTS Clear-to-Send
CW Codeword
CWS Contention Window Size
D2D Device-to-Device
DC Dual Connectivity, Direct Current
DCI Downlink Control Information
DF Deployment Flavour
DL Downlink
DMTF Distributed Management Task Force
DPDK Data Plane Development Kit
DM-RS, DMRS Demodulation Reference Signal
DN Data network
DNN Data Network Name
DNAI Data Network Access Identifier
DRB Data Radio Bearer
DRS Discovery Reference Signal
DRX Discontinuous Reception
DSL Domain Specific Language. Digital Subscriber Line
DSLAM DSL Access Multiplexer
DwPTS Downlink Pilot Time Slot
E-LAN Ethernet Local Area Network
E2E End-to-End
EAS Edge Application Server
ECCA extended clear channel assessment, extended CCA
ECCE Enhanced Control Channel Element, Enhanced CCE
ED Energy Detection
EDGE Enhanced Datarates for GSM Evolution (GSM Evolution)
EAS Edge Application Server
EASID Edge Application Server Identification
ECS Edge Configuration Server
ECSP Edge Computing Service Provider
EDN Edge Data Network
EEC Edge Enabler Client
EECID Edge Enabler Client Identification
EES Edge Enabler Server
EESID Edge Enabler Server Identification
EHE Edge Hosting Environment
EGMF Exposure Governance Management Function
EGPRS Enhanced GPRS
EIR Equipment Identity Register
eLAA enhanced Licensed Assisted Access, enhanced LAA
EM Element Manager
eMBB Enhanced Mobile Broadband
EMS Element Management System
eNB evolved NodeB, E-UTRAN Node B
EN-DC E-UTRA-NR Dual Connectivity
EPC Evolved Packet Core
EPDCCH enhanced PDCCH, enhanced Physical Downlink Control Cannel
EPRE Energy per resource element
EPS Evolved Packet System
EREG enhanced REG, enhanced resource element groups
ETSI European Telecommunications Standards Institute
ETWS Earthquake and Tsunami Warning System
eUICC embedded UICC, embedded Universal Integrated Circuit Card
E-UTRA Evolved UTRA
E-UTRAN Evolved UTRAN
EV2X Enhanced V2X
F1AP F1 Application Protocol
F1-C F1 Control plane interface
F1-U F1 User plane interface
FACCH Fast Associated Control CHannel
FACCH/F Fast Associated Control Channel/Full rate
FACCH/H Fast Associated Control Channel/Half rate
FACH Forward Access Channel
FAUSCH Fast Uplink Signalling Channel
FB Functional Block
FBI Feedback Information
FCC Federal Communications Commission
FCCH Frequency Correction CHannel
FDD Frequency Division Duplex
FDM Frequency Division Multiplex
FDMAFrequency Division Multiple Access
FE Front End
FEC Forward Error Correction
FFS For Further Study
FFT Fast Fourier Transformation
feLAA further enhanced Licensed Assisted Access, further enhanced LAA
FN Frame Number
FPGA Field-Programmable Gate Array
FR Frequency Range
FQDN Fully Qualified Domain Name
G-RNTI GERAN Radio Network Temporary Identity
GERAN GSM EDGE RAN, GSM EDGE Radio Access Network
GGSN Gateway GPRS Support Node
GLONASS GLObal’naya NAvigatsionnaya Sputnikovaya Sistema
(Engl.: Global Navigation Satellite System)
gNB Next Generation NodeB
gNB-CU gNB-centralized unit, Next Generation NodeB centralized unit
gNB-DU gNB-distributed unit, Next Generation NodeB distributed unit
GNSS Global Navigation Satellite System
GPRS General Packet Radio Service
GPSI Generic Public Subscription Identifier
GSM Global System for Mobile Communications, Groupe Spécial Mobile
GTP GPRS Tunneling Protocol
GTP-UGPRS Tunnelling Protocol for User Plane
GTS Go To Sleep Signal (related to WUS)
GUMMEI Globally Unique MME Identifier
GUTI Globally Unique Temporary UE Identity
HARQ Hybrid ARQ, Hybrid Automatic Repeat Request
HANDO Handover
HFN HyperFrame Number
HHO Hard Handover
HLR Home Location Register
HN Home Network
HO Handover
HPLMN Home Public Land Mobile Network
HSDPA High Speed Downlink Packet Access
HSN Hopping Sequence Number
HSPA High Speed Packet Access
HSS Home Subscriber Server
HSUPA High Speed Uplink Packet Access
HTTP Hyper Text Transfer Protocol
HTTPS Hyper Text Transfer Protocol Secure
(https is http/1.1 over SSL, i.e. port 443)
I-Block Information Block
ICCID Integrated Circuit Card Identification
IAB Integrated Access and Backhaul
ICIC Inter-Cell Interference Coordination
ID Identity, identifier
IDFT Inverse Discrete Fourier Transform
IE Information element
IBE In-Band Emission
IEEE Institute of Electrical and Electronics Engineers
IEI Information Element Identifier
IEIDL Information Element Identifier Data Length
IETF Internet Engineering Task Force
IF Infrastructure
IIOT Industrial Internet of Things
IM Interference Measurement, Intermodulation, IP Multimedia
IMC IMS Credentials
IMEI International Mobile Equipment Identity
IMGI International mobile group identity
IMPI IP Multimedia Private Identity
IMPU IP Multimedia PUblic identity
IMS IP Multimedia Subsystem
IMSI International Mobile Subscriber Identity
IoT Internet of Things
IP Internet Protocol
Ipsec IP Security, Internet Protocol Security
IP-CAN IP-Connectivity Access Network
IP-M IP Multicast
IPv4 Internet Protocol Version 4
IPv6 Internet Protocol Version 6
IR Infrared
IS In Sync
IRP Integration Reference Point
ISDN Integrated Services Digital Network
ISIM IM Services Identity Module
ISO International Organisation for Standardisation
ISP Internet Service Provider
IWF Interworking-Function
I-WLAN Interworking WLAN
Constraint length of the convolutional code, USIM Individual key
kB Kilobyte (1000 bytes)
kbps kilo-bits per second
Kc Ciphering key
Ki Individual subscriber authentication key
KPI Key Performance Indicator
KQI Key Quality Indicator
KSI Key Set Identifier
ksps kilo-symbols per second
KVM Kernel Virtual Machine
L1 Layer 1 (physical layer)
L1-RSRP Layer 1 reference signal received power
L2 Layer 2 (data link layer)
L3 Layer 3 (network layer)
LAA Licensed Assisted Access
LAN Local Area Network
LADN Local Area Data Network
LBT Listen Before Talk
LCM LifeCycle Management
LCR Low Chip Rate
LCS Location Services
LCID Logical Channel ID
LI Layer Indicator
LLC Logical Link Control, Low Layer Compatibility
LMF Location Management Function
LOS Line of Sight
LPLMN Local PLMN
LPP LTE Positioning Protocol
LSB Least Significant Bit
LTE Long Term Evolution
LWA LTE-WLAN aggregation
LWIP LTE/WLAN Radio Level Integration with IPsec Tunnel
LTE Long Term Evolution
M2M Machine-to-Machine
MAC Medium Access Control (protocol layering context)
MAC Message authentication code (security/encryption context)
MAC-A MAC used for authentication and key agreement
(TSG T WG3 context)
MAC-IMAC used for data integrity of signalling messages
(TSG T WG3 context)
MANO Management and Orchestration
MBMS Multimedia Broadcast and Multicast Service
MBSFN Multimedia Broadcast multicast service
Single Frequency Network
MCC Mobile Country Code
MCG Master Cell Group
MCOTMaximum Channel Occupancy Time
MCS Modulation and coding scheme
MDAFManagement Data Analytics Function
MDASManagement Data Analytics Service
MDT Minimization of Drive Tests
ME Mobile Equipment
MeNB master eNB
MER Message Error Ratio
MGL Measurement Gap Length
MGRP Measurement Gap Repetition Period
MIB Master Information Block, Management Information Base
MIMO Multiple Input Multiple Output
MLC Mobile Location Centre
MM Mobility Management
MME Mobility Management Entity
MN Master Node
MNO Mobile Network Operator
MO Measurement Object, Mobile Originated
MPBCH MTC Physical Broadcast CHannel
MPDCCH MTC Physical Downlink Control CHannel
MPDSCH MTC Physical Downlink Shared CHannel
MPRACH MTC Physical Random Access CHannel
MPUSCH MTC Physical Uplink Shared Channel
MPLS MultiProtocol Label Switching
MS Mobile Station
MSB Most Significant Bit
MSC Mobile Switching Centre
MSI Minimum System Information,
MCH Scheduling Information
MSID Mobile Station Identifier
MSIN Mobile Station Identification Number
MSISDN Mobile Subscriber ISDN Number
MT Mobile Terminated, Mobile Termination
MTC Machine-Type Communications
mMTCmassive MTC, massive Machine-Type Communications
MU-MIMO Multi User MIMO
MWUS MTC wake-up signal, MTC WUS
NACK Negative Acknowledgement
NAI Network Access Identifier
NAS Non-Access Stratum, Non- Access Stratum layer
NCT Network Connectivity Topology
NC-JT Non-Coherent Joint Transmission
NEC Network Capability Exposure
NE-DC NR-E-UTRA Dual Connectivity
NEF Network Exposure Function
NF Network Function
NFP Network Forwarding Path
NFPD Network Forwarding Path Descriptor
NFV Network Functions Virtualization
NFVI NFV Infrastructure
NFVO NFV Orchestrator
NG Next Generation, Next Gen
NGEN-DC NG-RAN E-UTRA-NR Dual Connectivity
NM Network Manager
NMS Network Management System
N-PoP Network Point of Presence
NMIB, N-MIB Narrowband MIB
NPBCH Narrowband Physical Broadcast CHannel
NPDCCH Narrowband Physical Downlink Control CHannel
NPDSCH Narrowband Physical Downlink Shared CHannel
NPRACH Narrowband Physical Random Access CHannel
NPUSCH Narrowband Physical Uplink Shared CHannel
NPSS Narrowband Primary Synchronization Signal
NSSS Narrowband Secondary Synchronization Signal
NR New Radio, Neighbour Relation
NRF NF Repository Function
NRS Narrowband Reference Signal
NS Network Service
NSA Non-Standalone operation mode
NSD Network Service Descriptor
NSR Network Service Record
NSSAINetwork Slice Selection Assistance Information
S-NNSAI Single-NSSAI
NSSF Network Slice Selection Function
NW Network
NWUSNarrowband wake-up signal, Narrowband WUS
NZP Non-Zero Power
O&M Operation and Maintenance
ODU2 Optical channel Data Unit - type 2
OFDMOrthogonal Frequency Division Multiplexing
OFDMA Orthogonal Frequency Division Multiple Access
OOB Out-of-Band
OOS Out of Sync
OPEX OPerating EXpense
OSI Other System Information
OSS Operations Support System
OTA over-the-air
PAPR Peak-to-Average Power Ratio
PAR Peak to Average Ratio
PBCH Physical Broadcast Channel
PC Power Control, Personal Computer
PCC Primary Component Carrier, Primary CC
P-CSCF Proxy CSCF
PCell Primary Cell
PCI Physical Cell ID, Physical Cell Identity
PCEF Policy and Charging Enforcement Function
PCF Policy Control Function
PCRF Policy Control and Charging Rules Function
PDCP Packet Data Convergence Protocol,
Packet Data Convergence Protocol layer
PDCCH Physical Downlink Control Channel
PDCP Packet Data Convergence Protocol
PDN Packet Data Network, Public Data Network
PDSCH Physical Downlink Shared Channel
PDU Protocol Data Unit
PEI Permanent Equipment Identifiers
PFD Packet Flow Description
P-GW PDN Gateway
PHICH Physical hybrid-ARQ indicator channel
PHY Physical layer
PLMN Public Land Mobile Network
PIN Personal Identification Number
PM Performance Measurement
PMI Precoding Matrix Indicator
PNF Physical Network Function
PNFD Physical Network Function Descriptor
PNFR Physical Network Function Record
POC PTT over Cellular
PP, PTP Point-to-Point
PPP Point-to-Point Protocol
PRACH Physical RACH
PRB Physical resource block
PRG Physical resource block group
ProSe Proximity Services, Proximity-Based Service
PRS Positioning Reference Signal
PRR Packet Reception Radio
PS Packet Services
PSBCH Physical Sidelink Broadcast Channel
PSDCH Physical Sidelink Downlink Channel
PSCCH Physical Sidelink Control Channel
PSSCH Physical Sidelink Shared Channel
PSCell Primary SCell
PSS Primary Synchronization Signal
PSTN Public Switched Telephone Network
PT-RS Phase-tracking reference signal
PTT Push-to-Talk
PUCCH Physical Uplink Control Channel
PUSCH Physical Uplink Shared Channel
QAM Quadrature Amplitude Modulation
QCI QoS class of identifier
QCL Quasi co-location
QFI QoS Flow ID, QoS Flow Identifier
QoS Quality of Service
QPSK Quadrature (Quarternary) Phase Shift Keying
QZSS Quasi-Zenith Satellite System
RA-RNTI Random Access RNTI
RAB Radio Access Bearer, Random Access Burst
RACH Random Access Channel
RADIUS Remote Authentication Dial In User Service
RAN Radio Access Network
RAND RANDom number (used for authentication)
RAR Random Access Response
RAT Radio Access Technology
RAU Routing Area Update
RB Resource block, Radio Bearer
RBG Resource block group
REG Resource Element Group
Rel Release
REQ REQuest
RF Radio Frequency
RI Rank Indicator
RIV Resource indicator value
RL Radio Link
RLC Radio Link Control, Radio Link Control layer
RLC AM RLC Acknowledged Mode
RLC UM RLC Unacknowledged Mode
RLF Radio Link Failure
RLM Radio Link Monitoring
RLM-RS Reference Signal for RLM
RM Registration Management
RMC Reference Measurement Channel
RMSI Remaining MSI, Remaining Minimum System Information
RN Relay Node
RNC Radio Network Controller
RNL Radio Network Layer
RNTI Radio Network Temporary Identifier
ROHC RObust Header Compression
RRC Radio Resource Control, Radio Resource Control layer
RRM Radio Resource Management
RS Reference Signal
RSRP Reference Signal Received Power
RSRQ Reference Signal Received Quality
RSSI Received Signal Strength Indicator
RSU Road Side Unit
RSTD Reference Signal Time difference
RTP Real Time Protocol
RTS Ready-To-Send
RTT Round Trip Time
Rx Reception, Receiving, Receiver
S1AP S1 Application Protocol
S1-MME S1 for the control plane
S1-U S1 for the user plane
S-CSCF serving CSCF
S-GW Serving Gateway
S-RNTI SRNC Radio Network Temporary Identity
S-TMSI SAE Temporary Mobile Station Identifier
SA Standalone operation mode
SAE System Architecture Evolution
SAP Service Access Point
SAPD Service Access Point Descriptor
SAPI Service Access Point Identifier
SCC Secondary Component Carrier, Secondary CC
SCell Secondary Cell
SCEF Service Capability Exposure Function
SC-FDMA Single Carrier Frequency Division Multiple Access
SCG Secondary Cell Group
SCM Security Context Management
SCS Subcarrier Spacing
SCTP Stream Control Transmission Protocol
SDAP Service Data Adaptation Protocol,
Service Data Adaptation Protocol layer
SDL Supplementary Downlink
SDNF Structured Data Storage Network Function
SDP Session Description Protocol
SDSF Structured Data Storage Function
SDT Small Data Transmission
SDU Service Data Unit
SEAF Security Anchor Function
SeNB secondary eNB
SEPP Security Edge Protection Proxy
SFI Slot format indication
SFTD Space-Frequency Time Diversity, SFN and frame timing difference
SFN System Frame Number
SgNB secondary gNB
SGSN Serving GPRS Support Node
S-GW Serving Gateway
SI System Information
SI-RNTI System Information RNTI
SIB System Information Block
SIM Subscriber Identity Module
SIP Session Initiated Protocol
SiP System in Package
SL Sidelink
SLA Service Level Agreement
SM Session Management
SMF Session Management Function
SMS Short Message Service
SMSF SMS Function
SMTC SSB-based Measurement Timing Configuration
SN Secondary Node, Sequence Number
SoC System on Chip
SON Self-Organizing Network
SpCell Special Cell
SP-CSI-RNTISemi-Persistent CSI RNTI
SPS Semi-Persistent Scheduling
SQN Sequence number
SR Scheduling Request
SRB Signalling Radio Bearer
SRS Sounding Reference Signal
SS Synchronization Signal
SSB Synchronization Signal Block
SSID Service Set Identifier
SS/PBCH Block SSBRI SS/PBCH Block Resource Indicator,
Synchronization Signal Block Resource Indicator
SSC Session and Service Continuity
SS-RSRP Synchronization Signal based Reference Signal
Received Power
SS-RSRQ Synchronization Signal based Reference Signal
Received Quality
SS-SINR Synchronization Signal based Signal to Noise
and Interference Ratio
SSS Secondary Synchronization Signal
SSSG Search Space Set Group
SSSIF Search Space Set Indicator
SST Slice/Service Types
SU-MIMO Single User MIMO
SUL Supplementary Uplink
TA Timing Advance, Tracking Area
TAC Tracking Area Code
TAG Timing Advance Group
TAI Tracking Area Identity
TAU Tracking Area Update
TB Transport Block
TBS Transport Block Size
TBD To Be Defined
TCI Transmission Configuration Indicator
TCP Transmission Communication Protocol
TDD Time Division Duplex
TDM Time Division Multiplexing
TDMA Time Division Multiple Access
TE Terminal Equipment
TEID Tunnel End Point Identifier
TFT Traffic Flow Template
TMSI Temporary Mobile Subscriber Identity
TNL Transport Network Layer
TPC Transmit Power Control
TPMI Transmitted Precoding Matrix Indicator
TR Technical Report
TRP, TRxP Transmission Reception Point
TRS Tracking Reference Signal
TRx Transceiver
TS Technical Specifications, Technical Standard
TTI Transmission Time Interval
Tx Transmission, Transmitting, Transmitter
U-RNTI UTRAN Radio Network Temporary Identity
UART Universal Asynchronous Receiver and Transmitter
UCI Uplink Control Information
UE User Equipment
UDM Unified Data Management
UDP User Datagram Protocol
USDF Unstructured Data Storage Network Function
UICC Universal Integrated Circuit Card
UL Uplink
UM Unacknowledged Mode
UML Unified Modelling Language
UMTS Universal Mobile Telecommunications System
UP User Plane
UPF User Plane Function
URI Uniform Resource Identifier
URL Uniform Resource Locator
URLLC Ultra-Reliable and Low Latency
USB Universal Serial Bus
USIM Universal Subscriber Identity Module
USS UE-Specific search space
UTRA UMTS Terrestrial Radio Access
UTRAN Universal Terrestrial Radio Access Network
UwPTS Uplink Pilot Time Slot
V2I Vehicle-to-Infrastruction
V2P Vehicle-to-Pedestrian
V2V Vehicle-to-Vehicle
V2X Vehicle-to-everything
VIM Virtualized Infrastructure Manager
VL Virtual Link,
VLAN Virtual LAN, Virtual Local Area Network
VM Virtual Machine
VNF Virtualized Network Function
VNFFG VNF Forwarding Graph
VNFFGD VNF Forwarding Graph Descriptor
VNFM VNF Manager
VoIP Voice-over-IP, Voice-over- Internet Protocol
VPLMN Visited Public Land Mobile Network
VPN Virtual Private Network
VRB Virtual Resource Block
WiMAX Worldwide Interoperability for Microwave Access
WLANWireless Local Area Network
WMAN Wireless Metropolitan Area Network
WPANWireless Personal Area Network
X2-C X2-Control plane
X2-U X2-User plane
XML eXtensible Markup Language
XRES EXpected user RESponse
XOR eXclusive OR
ZC Zadoff-Chu
ZP Zero Power

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-20. (canceled)

21. A base station comprising:
one or more processors; and
one or more non-transitory computer-readable media comprising instructions that, upon execution of the instructions by the one or more processors, are to cause the base station to:
identify that a full duplex (FD) symbol is to be transmitted in a transmission period;
identify, based on the identification that a FD symbol is to be transmitted in the transmission period, one or more transmission parameters related to a unidirectional transmission; and
facilitate wireless unidirectional transmission based on the one or more transmission parameters;
wherein the FD symbol is a symbol capable of simultaneous uplink (UL) and downlink (DL) transmission in the same symbol.

22. The base station of claim 21, wherein the FD symbol is a non-overlapping sub-band FD (NOSB-FD) symbol.

23. The base station of claim 21, wherein the one or more transmission parameters include one or more DL transmission parameters or one or more UL transmission parameters.

24. The base station of claim 21, wherein the one or more transmission parameters are applied to all occasions in the transmission period.

25. The base station of claim 21, wherein:
the one or more transmission parameters are first one or more transmission parameters;
the first one or more transmission parameters are applied to a first occasion in the transmission period; and
second one or more transmission parameters are applied to a second occasion in the transmission period.

26. The base station of claim 21, wherein occasions of the unidirectional transmission in the transmission period are within FD symbols and not within non-FD symbols.

27. The base station of claim 21, wherein occasions of the unidirectional transmission in the transmission period are within FD symbols and within non-FD symbols.

28. An apparatus for use in a user equipment (UE), wherein the apparatus comprises:
memory to store an indication received from a base station; and
one or more processors configured to:
identify, based on the indication, one or more transmission parameters related to a unidirectional wireless transmission, wherein the one or more transmission parameters are based on identification by the base station that a full duplex (FD) symbol is to be transmitted by the base station in a transmission period, wherein the FD symbol is a symbol capable of simultaneous UL and DL transmission in the same symbol; and
facilitate the unidirectional wireless transmission based on the one or more transmission parameters.

29. The apparatus of claim 28, wherein the FD symbol is a non-overlapping sub-band FD (NOSB-FD) symbol.

30. The apparatus of claim 28, wherein the one or more transmission parameters include one or more DL transmission parameters or one or more UL transmission parameters.

31. The apparatus of claim 28, wherein the one or more transmission parameters are applied to all occasions in the transmission period.

32. The apparatus of claim 28, wherein:
the one or more transmission parameters are first one or more transmission parameters;
the first one or more transmission parameters are applied to a first occasion in the transmission period; and
second one or more transmission parameters are applied to a second occasion in the transmission period.

33. The apparatus of claim 28, wherein occasions of the unidirectional transmission in the transmission period are within FD symbols and not within non-FD symbols.

34. The apparatus of claim 28, wherein occasions of the unidirectional transmission in the transmission period are within FD symbols and within non-FD symbols.

35. One or more non-transitory computer-readable media comprising instructions that, upon execution of the instructions by one or more processors of a user equipment (UE), are to cause the UE to:
identify an indication of a Non-Overlapping Sub-Band Full Duplex (NOSB-FD) configuration, wherein the NOSB-FD configuration includes a time and frequency resource allocation;
determine, based on the NOSB-FD configuration, one or more parameters for transmission of an uplink control information (UCI); and
transmit the UCI based on the determined one or more parameters.

36. The one or more non-transitory computer-readable media of claim 35, wherein the one or more parameters include one or more physical uplink control channel (PUCCH) transmission parameters.

37. The one or more non-transitory computer-readable media of claim 35, wherein the one or more parameters are identified prior to performance of a multiplexing procedure related to the UCI.

38. The one or more non-transitory computer-readable media of claim 35, wherein the one or more parameters are identified subsequent to performance of a multiplexing procedure related to the UCI.

39. The one or more non-transitory computer-readable media of claim 35, wherein the one or more parameters include one or more physical uplink shared channel (PUSCH) parameters.

40. The one or more non-transitory computer-readable media of claim 35, wherein the one or more parameters are based on which of a plurality of operation modes are to be used the transmission of the UCI, wherein the plurality of operation modes include:
an operation mode A that relates to transmission in NOSB-FD symbols; and
an operation mode B that relates to transmission in symbols that are not NOSB-FD symbols.
